(19) United States
(12) Patent Application Publication
(10) Pub. No.: US 2025/0079775 A1
(43) Pub. Date: Mar. 6, 2025

(54) DOORS FOR HOME APPLIANCE AND HOME APPLIANCE INCLUDING THE SAME

(71) Applicant: LG ELECTRONICS INC., Seoul (KR)

(72) Inventor: DongWoo Kim, Seoul (KR)

(21) Appl. No.: 18/817,399

(22) Filed: Aug. 28, 2024

(30) Foreign Application Priority Data
Aug. 29, 2023 (KR) 10-2023-0113784

(51) Int. Cl. H01R 13/73; F24C 15/04

(52) U.S. Cl. CPC H01R 13/73; F24C 15/04

(57) ABSTRACT

A door for a home appliance includes a door body disposed in front of a storage space of the home appliance, with an electronic component disposed therein. A connector module is disposed in the door body. The connector module includes a mounting base, and a movement supporter moved along the mounting base. A door connector is disposed at the movement supporter and moved with the movement supporter along the mounting base. The movement supporter is mounted to the mounting base in a first direction. The movement supporter is moved relatively to the mounting base in a second direction. The door connector mounted in a different direction to the movement direction may be maintained in the mounted state without being separated arbitrarily from the door.

### CROSS REFERENCE TO RELATED APPLICATIONS

The present application claims priority to and the benefit of Korean Patent Application No. 10-2023-0113784, filed on Aug. 29, 2023, the disclosure of which is incorporated herein by reference in its entirety.

### TECHNICAL FIELD

The present disclosure relates to a door for a home appliance.

### BACKGROUND

Home appliances may store target objects and include doors. For example, home appliances include a cooking appliance, a refrigerator, a clothing treating apparatus, etc. The home appliances may include storage spaces for storing target objects in cabinets, creating the external appearance thereof, and doors to open and close the storage spaces.

Various electronic components may be installed in the door of the home appliance. For example, a touch sensor device, a display device, etc. may be installed in the door.

The electronic components may be electrically connected to a main controller provided in a main body of the home appliance with one or more wires.

To facilitate the connection of the wire, the wire may be connected to a connector. For example, a door connector protruding from the door and a main body connector protruding from the main body of the home appliance may be assembled with each other. As described above, the door connector and the main body connector (which is also referred to as “connector assembly” in this disclosure) are disposed not to be exposed outward. For example, the connector assembly is stored in a frame of the main body close to the door and a storage entrance may be covered with a separate cover.

For instance, assembling of the connector assembly may be performed after the door is assembled to the main body. After the door is assembled to the main body, the door connector may be assembled to the main body connector. However, a narrow gap between the door and the main body may make the assembly of the connectors difficult.

Furthermore, to reduce exposure of the wire and the connector assembly, the connector assembly and the wire may be disposed at a lower portion of the main body. In this case, the assembly operation of the connector assembly may be performed at lower portions of the main body and the door. Accordingly, an operator (e.g., assembler) must put together the connector assembly without accurately checking the connector assembly with the naked eye, which requires skill in the assembly operation of the connector assembly and reduces the workability.

Specifically, a connector has directionality, and the operator must perform the assembly operation in the narrow space between the main body and the door while checking the direction of the connector assembly, which further reduces workability.

In some examples, regarding the home appliance, products such as cooking appliance that create high-temperature environments in a storage space cause the main bodies to be heated to high temperatures. As described above, the high temperature of the main body affects the connector assembly, reducing durability of the connector assembly and resulting in damage to the connector assembly.

In addition, due to the narrow inner space of the frame of the main body adjacent to the door, maintenance of the connector assembly is difficult. Specifically, to insert the connector assembly into the frame, or to remove the connector assembly inside the frame outward, the operator must access the connector assembly through the narrow inner space of the frame, which reduces workability. Furthermore, when the operator inserts the connector assembly deep inside the frame, it may be difficult to remove the connector assembly.

In some examples, the conventional connector assembly may not be guided along a specific path and may be installed to move freely when pulled by the connected wire. Accordingly, in such cases, the operator must precisely grip and fix the two connectors with both hands before assembling the connectors. However, as described above, when the two connectors are assembled in a narrow space, it may be difficult to grip and assemble the connectors, which may be a disadvantage.

In addition, a wire installed in the main body of the home appliance and a wire installed in the door may be fixed by separate fasteners at regular intervals for assembly stability. As described above, the connectors provided at terminal ends of the wires fixed by the fasteners are limited in terms of movable distances and directions. When the wires are sufficiently long, the operational distance for coupling the connectors increases, which improves workability. However, long exposed sections of wires that extend outward deteriorate the aesthetics and reduces the durability, as the sheath may be damaged due to friction with the external part. On the other hand, when the wires are shortened, the sections where the wires are exposed outward are shortened, improving the aesthetics and reducing friction with the external part. However, there creates some issues as the workability of assembling the two connectors is reduced.

### SUMMARY

The present disclosure has been made keeping in mind the above problems occurring in the related art, and an objective of the present disclosure is to assemble a wire connected to an electronic component disposed in a door and a connector with a relative connector and then store the assembly in the door and maintain the stored state thereof.

Another objective of the present disclosure is to prevent a connector mounted to an inside part of a door from being separated arbitrarily and to move the connector along a certain path between a storage position and an operation position.

Yet another objective of the present disclosure is to restrict a connector at an operation position when the connector is moved to the operation position to be assembled or separated.

Still another objective of the present disclosure is to adjust the storage depth of a connector in a door to respond to a variety of extra lengths of a wire.

Aspects of the present disclosure are not limited to the above-described ones. Additionally, other aspects and advantages that have not been mentioned can be clearly understood from the following description and can be more clearly understood from implementations. Further, it will be understood that the aspects and advantages of the present disclosure can be realized via means and combinations thereof that are described in the appended claims.

According to the features of the present disclosure to achieve the above-described objectives, a door for a home appliance of the present disclosure may include a door body disposed in front of a storage space of the home appliance and in which an electronic component is disposed. A connector module may be disposed in the door body. The connector module may include a mounting base, and a movement supporter moved along the mounting base. A door connector may be disposed at the movement supporter and moved with the movement supporter along the mounting base. At this point, the movement supporter may be mounted to the mounting base in a first direction. The movement supporter may be moved relatively to the mounting base in a second direction that is different from the first direction. As described above, the door connector mounted in a different direction to the movement direction may be maintained in the mounted state without being separated arbitrarily from the inside part of the door.

In addition, the movement supporter may be mounted to the mounting base at a first position of the mounting base. The movement supporter may slide from the first position to a second position in the second direction. The door connector and a relative connector may be reciprocated between a storage position and an operation position along a preset path. A fabricator may easily move the connectors or the movement supporter to the desired position by pulling and pushing the connectors or the movement supporter.

Furthermore, the mounting base may include a guide slot in the second direction. The movement supporter may include a guide arm inserted into the guide slot in the first direction. When the guide arm is inserted into the guide slot, the movement supporter may be prevented from being separated from the mounting base in a direction opposite to the first direction.

In addition, when the guide arm is inserted into the guide slot, the guide slot may guide the movement of the movement supporter in the second direction.

Furthermore, the guide slot may include a slot entrance with an opening width larger than other portions of the guide slot. The guide arm may include a guide head inserted into the guide slot. The thickness of the guide head may be larger than the thickness of the guide slot and smaller than or equal to the thickness of the guide head.

In addition, the mounting base and the movement supporter may include a storage fixation part fixing the movement supporter to a storage position. The storage fixation part may include a first position fixation part provided at the mounting base and a second position fixation part caught by the first position fixation part to fix the movement supporter at the storage position.

Furthermore, the position fixation part may have a cantilever structure protruding from the movement supporter. A fixation end portion may protrude from one end of the position fixation part and be supported by the first position fixation part.

In addition, a pair of first position fixation parts may be provided at both side portions of the mounting base. A pair of second position fixation parts may be provided at both side portions of the movement supporter, and face the pair of first position fixation part.

The movement supporter may be restricted at the first position and the second position by the mounting base while being moved in the second direction.

In addition, a mounting stopper may protrude from the mounting base. The mounting stopper may interfere with the movement supporter at the first position.

Furthermore, the mounting base may include a restraint maintaining part, which is moved in the second direction to interfere with a part of the movement supporter disposed at the operation position to restrict the movement of the movement supporter. As described above, when the door connector maintains the fixed state at the operation position, operations of assembling the relative connector to the door connector or of separating the relative connector from the door connector may be easily performed.

In addition, the movement supporter may be turned in a third direction that is different from the first direction and the second direction, and the locked state may be removed. Since the door connector may be changed from the locked state to the released state with the turning of the movement supporter, the fabricator can easily move the door connector in a one-touch method.

Furthermore, the movement supporter may include a supporter restraint arm that may interfere with the restraint maintaining part and be elastically deformed.

In addition, when the supporter restraint arm is turned or elastically deformed, the supporter restraint arm may be released from interference with the restraint maintaining part.

Furthermore, the restraint maintaining part may include a locking step fixing the supporter restraint arm due to interference, and a releasing step provided at a different height from the locking step. The releasing step may be prevented from interfering with the supporter restraint arm.

In addition, the releasing step may be formed such that a width is gradually widened in the second direction. A releasing surface of a curved surface or an inclined surface may be provided on a surface of the releasing step.

Furthermore, the locking step may include a locking surface having a flat surface shape. One end of the supporter restraint arm may be caught by the locking surface.

In addition, when the movement supporter is turned, the supporter restraint arm may be moved from a position facing the locking step to a position facing the releasing step.

Furthermore, an operation lever may protrude from the movement supporter in a second movement direction. When the movement supporter is restricted by the restraint maintaining part, the operation lever may be disposed at an entrance of the connector storage part.

In addition, the mounting base may include a guide slot in the second direction. The movement supporter may include a guide head passing through the guide slot and then caught by an edge of the guide slot. A spacing may be provided between the guide head and the edge of the guide slot. The movement supporter may be relatively turned in a direction reducing the spacing with respect to the mounting base.

Furthermore, a guide step may protrude from the mounting base. The guide step may cover a surface of the movement supporter to prevent the movement supporter from being separated from the mounting base in a direction opposite to the first direction.

In addition, the mounting base may include an assembly piece elastically deformed in a direction away from a surface of the movement supporter. The movement supporter may interfere with the assembly piece while being assembled in the first direction and elastically deform the assembly piece.

Furthermore, the guide slot may extend in the first direction and the second direction. The movement supporter may be inserted into the guide slot in the first direction and then be moved along the guide slot in the second direction.

In addition, a door panel may be disposed at a central portion of the door body. The door panel may include a window through which the storage space is visible. An indoor space defined by the door body and the door panel may include an installation region around an outer portion of the window. The connector storage part may be disposed at the installation region.

Furthermore, the door connector may include an assembly surface assembled to the relative connector disposed at a main body of the home appliance or a connection connector outside the home appliance. When the door connector may be moved to the operation position, the assembly surface of the door connector may be exposed outside the connector entrance.

As described above, the doors of a home appliance and the home appliance including the same according to the present disclosure have the following effects.

In the present disclosure, the door connector connected to the electronic component in the door may be mounted to the inside part in the first direction and then moved in the second direction. As described above, the door connector mounted in a different direction to the movement direction may be maintained in the mounted state without being separated arbitrarily from the inside part of the door. Therefore, the storage performance of the connectors can be improved.

In addition, the door connector and the relative connector connected to the door connector may be mounted to the mounting base while being fixed to the movement supporter and may be moved along the mounting base. The door connector and the relative connector may be reciprocated between the storage position and the operation position along a preset path. The fabricator can easily move the connectors or the movement supporter to the desired position by pulling and pushing the connectors or the movement supporter. Accordingly, the assemblability and the maintainability of the connectors can also be improved.

Furthermore, in the present disclosure, when the door connector and the movement supporter are moved to the operation position, the restraint maintaining part of the mounting base may restrict positions of the door connector and the movement supporter. As described above, when the door connector maintains the fixed state at the operation position, operations of assembling the relative connector to the door connector or of separating the relative connector from the door connector can be easily performed.

In addition, when the movement supporter is turned, the movement supporter and the door connector may be released from the state where the movement supporter and the door connector are restricted by the restraint maintaining part. Since the door connector may be changed from the locked state to the released state with the turning of the movement supporter, the fabricator can easily move the door connector in a one-touch method. Therefore, workability in assembly/separation of the connectors can be improved.

Specifically, the restraint maintaining part of the present disclosure includes the locking step and the releasing step, so the movement supporter may be caught and fixed or be movable depending on positions of the movement supporter. As described above, according to the present disclosure, the door connector can be fixed without a separate fastener, and the number of parts and the number of man-hours can be reduced.

In addition, in the present disclosure, the door connector and the relative connector coupled thereto may be fixed to various positions by the storage fixation part provided along the connector storage part. Accordingly, the mounting depth of the door connector and the relative connector can be varied, and a variety of extra lengths of the wires connected to the connectors can be accommodated. Therefore, the assembly compatibility of the connectors can be improved.

Furthermore, in the present disclosure, the connectors are stored in the door, not the main body of the home appliance. Accordingly, the connectors can be less affected by harsh environments of the main body in which the temperature and the humidity are excessively high or low. Accordingly, the durability of the connectors can be improved, and the operation reliability of the connectors can be improved.

Specifically, in the present disclosure, the door connector and the relative connector may be disposed in the edge portion (installation region) provided around the window of the door. Therefore, the door connector and the relative connector can be covered by the edge portion when being located in the storage position, so it is possible to prevent outward exposure of the door connector and the relative connector.

Furthermore, in the present disclosure, the door connector is mounted to the movement supporter first and then is moved with the movement supporter along the mounting base. Since the structure to move the door connector should be provided in the movement supporter and the mounting base, the existing door connector can be used. Therefore, the present disclosure has the effect of high compatibility of the connector.

Furthermore, in the present disclosure, the mounting base includes the mounting stopper. The mounting stopper may limit the storage depth of the door connector. Accordingly, it is possible to prevent the door connector and the relative connector can be prevented from being moved to and stored in a position too deep in the door.

### BRIEF DESCRIPTION OF THE DRAWINGS

FIG. 1 is a perspective view illustrating an embodiment of a home appliance according to the present disclosure.

FIG. 2 is a perspective view illustrating the embodiment of the present disclosure with a separated side cover constituting the embodiment.

FIG. 3 is a perspective view illustrating a lower door constituting the embodiment of the present disclosure.

FIG. 4 is an exploded perspective view illustrating main components of the lower door constituting the embodiment of the present disclosure.

FIG. 5 is a perspective view, in greater detail than FIG. 4, illustrating the main components of the lower door constituting the embodiment of the present disclosure.

FIG. 6 is a perspective view illustrating a structure of the lower door, an image acquisition module, a connector module, a main wire, and a connector wire constituting the embodiment of the present disclosure.

FIG. 7 is a perspective view illustrating the connector module constituting the embodiment of the present disclosure assembled at a lower portion of the lower door.

FIGS. 8A and 8B are perspective views illustrating the connector module constituting the embodiment of the present disclosure before and after being stored into the lower door.

FIG. 9 is a perspective view illustrating the internal part of the lower door without a rear frame and an inner frame of the lower door constituting the embodiment of the present disclosure.

FIG. 10 is a sectional view taken along line X-X′ of FIG. 9.

FIG. 11 is a perspective view illustrating an embodiment of the connector module constituting the door for a home appliance according to the present disclosure.

FIG. 12 is a perspective view illustrating the embodiment of the connector module according to the present disclosure in a mounted state to the lower door, without the lower door.

FIG. 13 is a perspective view illustrating a movement supporter and a door connector separated from each other in a mounting base constituting the embodiment of the connector module according to the present disclosure.

FIG. 14 is a plan view illustrating the movement supporter coupled to the mounting base constituting the embodiment of the connector module according to the present disclosure.

FIG. 15 is a plan view illustrating the movement supporter and the door connector coupled to the mounting base constituting the embodiment of the connector module according to the present disclosure.

FIG. 16 is a plan view illustrating the movement supporter, the door connector, and a main connector connected to the mounting base constituting the embodiment of the connector module according to the present disclosure.

FIG. 17 is a plan view illustrating the movement supporter, the door connector, and the main connector moved upward from FIG. 3.

FIG. 18 is a perspective view illustrating a structure of the mounting base constituting the embodiment of the connector module according to the present disclosure.

FIG. 19 is a perspective view illustrating a structure of the movement supporter constituting the embodiment of the connector module according to the present disclosure.

FIG. 20 is a perspective view illustrating the door connector mounted to the movement supporter constituting the embodiment of the connector module according to the present disclosure.

FIG. 21 is a perspective view illustrating the structure of FIG. 20 at a different angle from FIG. 20.

FIG. 22 is a sectional view taken along line XXII-XXII′ of FIG. 17.

FIG. 23 is a sectional view illustrating the state of FIG. 22 without the door connector and the main connector.

FIG. 24 is a sectional view taken along line XXIV-XXIV of FIG. 17.

FIG. 25 is a perspective view illustrating the movement supporter and a connector assembly constituting the embodiment of the connector module according to the present disclosure, the movement supporter and the connector assembly being disposed at a storage position.

FIG. 26 is a perspective view illustrating the state of FIG. 25 at a different angle from FIG. 25.

FIG. 27 is a perspective view illustrating the movement supporter and the connector assembly constituting the embodiment of the connector module according to the present disclosure, the movement supporter and the connector assembly being disposed at an operation position.

FIG. 28 is a perspective view illustrating the state of FIG. 27 at a different angle from FIG. 27.

FIG. 29 is a perspective view illustrating the state of FIG. 27 at a different angle from FIGS. 27 and 28.

FIG. 30 is a perspective view illustrating the main connector separated from the embodiment of the connector module according to the present disclosure.

FIG. 31 is an enlarged view illustrating part A of FIG. 30.

FIG. 32 is an enlarged view illustrating part B of FIG. 30.

FIG. 33 is an enlarged view illustrating the movement supporter in a released state from the embodiment of the connector module according to the present disclosure.

FIG. 34 is a perspective view illustrating the embodiment of the connector module according to the present disclosure located at the operation position.

FIG. 35 is a perspective view illustrating the movement supporter of FIG. 34 turned from the mounting base into a released state.

FIG. 36 is an enlarged view illustrating the state of FIG. 35 when viewed from the side space.

FIG. 37 is a perspective view illustrating another embodiment of a door for a home appliance according to the present disclosure.

FIG. 38 is a perspective view illustrating another embodiment of the home appliance according to the present disclosure.

### DETAILED DESCRIPTION

The present disclosure relates to one or more doors for an appliance, e.g., a home appliance. For example, the home appliance can include a storage space 31, 41 therein. The door can open and close the storage space 31, 41. The door can be applied to various home appliances such as a cooking appliance, a refrigerator, a freezer, a kimchi refrigerator, a plant cultivating apparatus, Styler®, a washing machine, etc. In some examples, the door can be applied to a door of furniture or an entrance door. In some implementations, the door includes two doors 50 and 70, but the door of the present disclosure can also be applied to a home appliance equipped with a single lower door 70. Hereinafter, the present disclosure will describe an example in which two doors 50 and 70 are applied to a cooking appliance. Furthermore, a door at a relatively upper side of the two doors 50 and 70 can be called an upper door 50, and a door at a lower side can be called a lower door 70.

In some implementations, an electronic component can be disposed in the lower door 70 of the doors 50, 70. The electronic component can provide various functions to the lower door 70. For example, when the electronic component is an image acquisition module 100, the image acquisition module 100 can be used to obtain an inside image through a storage space 41. The lower door 70 can include the inner illuminance of the storage space 41. In some examples, the image acquisition module 100 can include an image sensing device 170 and a lighting device 180.

In some implementations, a display device can be disposed at the lower door 70 as an electronic component. The display device can provide the information of the home appliance to a user. The user can input an operational command through the display device.

The image acquisition module 100 or a part of the display device can be provided in the lower door 70. At this point, the electronic component such as the image acquisition module 100, the display device, or the like can receive and transmit an electric signal with a main controller provided in a main body of the home appliance, or can be connected to the main body with a wire to supply power.

At this point, a connector 270, 290 can be connected to the wire. The connector 270, 290 can include a door connector 270 disposed in the lower door 70 and a main connector disposed in the main body. The door connector 270 can be assembled with the main connector to be electrically connected thereto. On the other hand, the door connector 270 may not be assembled with the main connector, but an external connection connector. Herein, both the main connector and the connection connector will be called a relative connector 290.

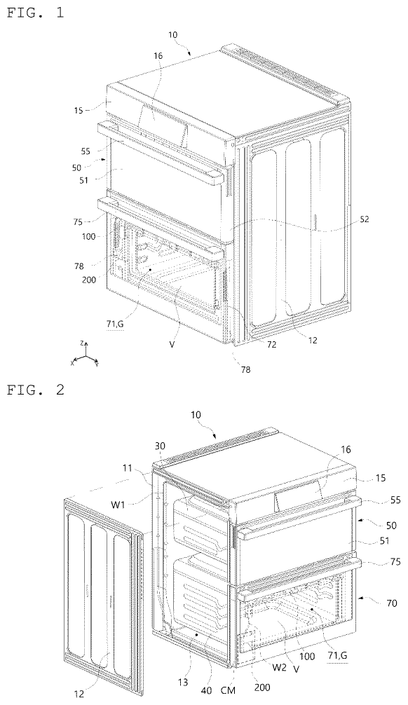

Referring to FIG. 1, the view illustrates a cooking appliance equipped with the doors 50 and 70. A main body 10 of the cooking appliance may be roughly shaped into a hexahedral form. In the embodiment, the main body 10 of the cooking appliance may include two doors 50 and 70. The two doors 50 and 70 may be disposed at different heights. The two doors 50 and 70 may serve to respectively shield different storage spaces.

FIG. 2 illustrates a separated state of a side cover 12 constituting the main body 10 of the cooking appliance. When the side cover 12 is separated, an internal space 13 of the main body 10 of the cooking appliance may be exposed. Two cabinets 30 and 40 may be disposed inside the inside space 13 at different heights. The two cabinets 30 and 40 may include the storage spaces separated from each other. As another example, the inside space 13 may include one cabinet or three or more cabinets 30 and 40. As another example, the two cabinets 30 and 40 may be disposed transversely. Reference numeral 11 indicates a rear cover constituting the main body 10 of the cooking appliance.

An upper panel 15 may be provided at an upper portion of the cooking appliance. The upper panel 15 may be disposed on an upper end portion of a front surface of the cooking appliance. The upper panel 15 may include an operating part 16. The operating part 16 may be used to operate functions of the cooking appliance and display a state of the cooking appliance. The operating part 16 may be composed of a display capable of being operated in a touch manner. As another example, the operating part 16 may include a knob rotatably moved. As another example, the operating part 16 may be omitted, and the display device may be disposed at the lower door 70.

The upper panel 15 may be connected to a main wire W1. The main wire W1 may connect the operating part 16 and a main controller (not illustrated) to each other. Otherwise, the main wire W1 may connect the operating part 16 to the electronic component of the lower door 70, such as the image acquisition module 100. The main wire W1 may be connected to a connection wire W2 described below, through a door wire W2.

The two cabinets 30 and 40 may be classified into a first cabinet 30 and a second cabinet 40. The first cabinet 30 and the second cabinet 40 may be disposed in the inside space 13 at different heights. An upper storage space may be provided in a first cabinet 30. A main storage space may be provided in the second cabinet 40. Herein, the upper storage space and the main storage space are separated from each other, and may be open only at the front portions.

The upper door 50 may be disposed in front of the first cabinet 30. The lower door 70 may be disposed in front of the second cabinet 40. In the embodiment, the upper door 50 and the lower door 70 may be operated in a kind of pull-down method in which each upper end is vertically swung on a lower end thereof. As another example, the upper door 50 and the lower door 70 may be operated in a side swing method in which each door is opened sideways.

In the upper door 50, a front surface 51 of the upper door 50 may have a structure allowing the upper storage space to be visible. For example, the front surface 51 of the upper door 50 has a glass panel structure, and a user can observe the inside part of the upper storage space through the upper door 50. As another example, the front surface 51 of the upper door 50 may be made of dark materials or be coated with a separate film, thereby preventing the upper storage space from being visible from the outside. Reference numeral 55 indicates a first handle to open and close the upper door 50.

The lower door 70 may be disposed below the upper door 50. The lower door 70 may be disposed in front of the second cabinet 40. The main storage space may be visible through a front surface of the lower door 70. The user can observe the inside of the main storage space through the front surface of the lower door 70.

In the embodiment, the lower door 70 may include a window V. The window V allows the main storage space to be visible from the outside space and may be made of a transparent material. The window V may be understood as a part of a front panel Ga constituting the front surface of the lower door 70. The window V may be provided in a central portion of the front panel Ga. For example, an edge portion of the front panel Ga may have a material with higher surface roughness unlike the window V. Otherwise, a separate opaque film may be applied to the edge portion of the front panel Ga. Then, excluding the window V, the edge portion of the front panel Ga prevents the main storage space form being visible.

As another example, the edge of the front panel Ga corresponding to the outside part of the window V may be covered by a door frame 72, 77, 80, 90. Herein, the outside part of the window V may be the edge portion of the front panel Ga that surrounds the edges of the window V with the window V as the center.

As another example, the lower door 70 may be made of dark materials or coated with a separate film, thereby preventing the main storage space from being visible from the outside space. As another example, in the lower door 70, the door panel G which will be described below may be omitted, and an opaque metallic or nonmetallic plate may constitute the front surface thereof. Also, in this case, the main storage space may not be visible from the outside space.

FIG. 2 illustrates the image acquisition module 100 and the connector module 200 which are mounted inside the lower door 70. Although FIG. 2 illustrates the image acquisition module 100 and the connector module 200 indicating positions where the image acquisition module 100 and the connector module 200 are mounted inside the lower door 70, the image acquisition module 100 and the connector module 200 may not be visible from the front space of the cooking appliance. This is because, as described above, the edge portion of the front panel Ga excluding the window Vis opaque. Reference numeral 75 indicates a second handle to open and close the lower door 70.

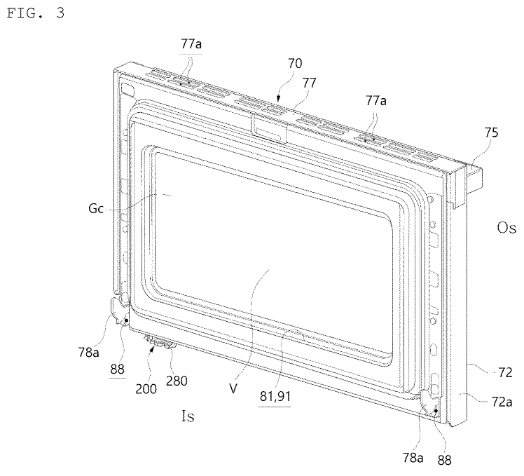

FIG. 3 illustrates the lower door 70 when viewed from the rear side. The front surface of the lower door 70 may have a flat surface structure. In the embodiment, the surface of the front panel Ga may constitute the front surface of the lower door 70.

The window V may be provided in the central portion of the front surface of the lower door 70. The window V may be a portion made of a transparent or translucent material so that the main storage space may be visible from the outside space. The window V may be located through a central portion of a plurality of panels constituting the door panel G. FIG. 3 illustrates the window V provided in a central portion of a second rear panel Gc constituting the door panel G.

A frame of the lower door 70 may be formed from the door body. The door body may include the door frame 72, 77, 80, 90 and the door panel G. The door body may have roughly a hexahedral structure when the door frame 72, 77, 80, 90 and the door panel G are assembled.

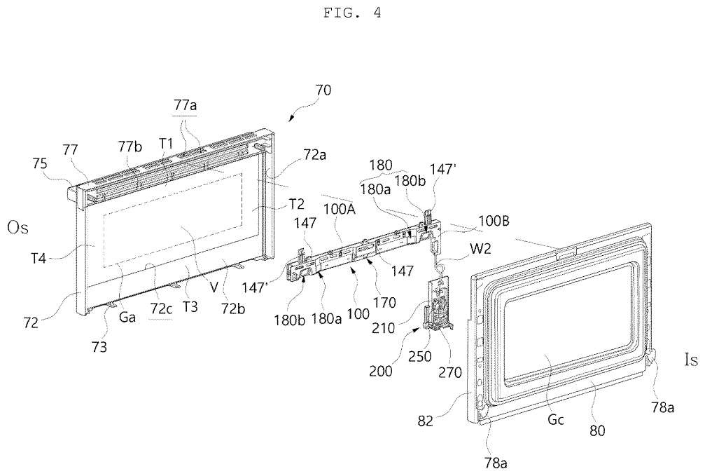

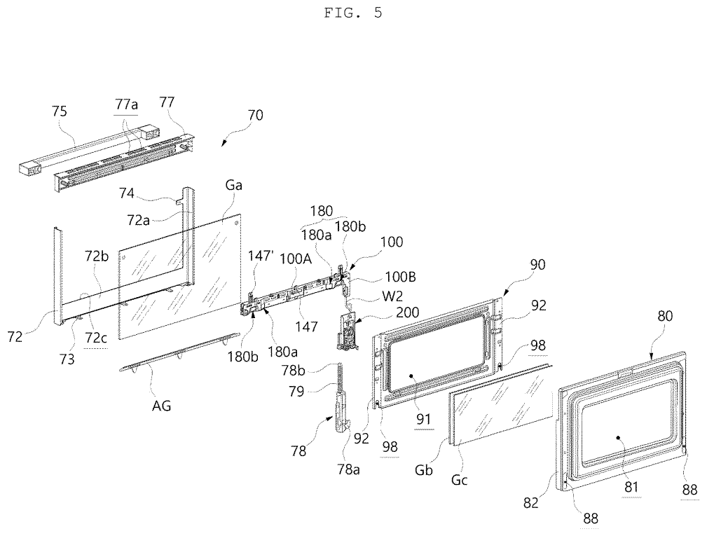

Referring to FIGS. 4 and 5, the door frame 72, 77, 80, 90 may include multiple frame parts. In the embodiment, the door frame 72, 77, 80, 90 may include a front frame part 72, a rear frame part 80, an inner frame part 90, and the upper frame part 77. The frame parts may be coupled to each other to provide one door frame 72, 77, 80, 90.

Herein, “front” is based on the front side of the lower door 70. For reference, in the entire drawings including FIG. 4, “Is” indicates the inside area of the lower door 70 facing the storage space, and “Os” indicates the outside area of the home appliance, i.e., the outside space of the lower door 70.

The front frame part 72 may be disposed at the front part of the door frame 72, 77, 80, 90. More specifically, the front frame part 72 may form a front frame of the door frame 72, 77, 80, 90. The front frame part 72 may be formed roughly in a rectangular frame shape. The front frame part 72 may be formed in a rectangular frame shape with an upper portion and a lower portion open upward and downward, respectively. A pair of front side plates 72a may be provided at both sides of the front frame part 72. The pair of front side plates 72a may stand vertically. A front lower plate 72b may connect the pair of front side plates 72a to each other while being located therebetween. The front side plates 72a and the front lower plate 72b are connected to each other to form roughly a “U” shape.

A front opening 72c may be provided between the front side plates 72a and the front lower plate 72b. The front opening 72c may be an empty space open in a longitudinal direction. The front panel Ga constituting the door panel G (referring to FIG. 1) may be disposed in the front opening 72c. It may be understood that an open portion of the front opening 72c is filled with the front panel Ga.

More specifically, the region of the door panel G is wider than the region of the front opening 72c, so a part of the front side plates 72a and a part of the front lower plate 72b may be stacked with the door panel G respectively. The front side plates 72a, the front lower plate 72b, and the front panel Ga may be coupled to each other by an adhesive or an adhesive tape. FIG. 4 illustrates the front panel Ga and the front frame part 72 stacked to each other. FIG. 4 illustrates the front panel Ga with a lower portion covering most of a rear surface of the front lower plate 72b.

With the second front side plates 72a of the front frame part 72 located in the center, the front panel Ga may be disposed at one side. The second handle 75 may be disposed at the opposite side of the second front side plates 72a. Herein, a separate fastener (not illustrated) passes through the second front side plates 72a and the front panel Ga and then may be fastened to a handle assembly part 75a of the second handle 75.

A lower frame part 73 may be provided at a lower end of the front frame part 72. The lower frame part 73 may be a part of the front frame part 72 or a separate object. The lower frame part 73 may have a shape bent from the lower end of the front frame part 72. The lower frame part 73 may include a connector inlet 73a. The connector inlet 73a may be provided at an operation position described below. A fabricator may access a connector storage part CM through the connector inlet 73a.

The image acquisition module 100 may be disposed in rear of the front panel Ga. Herein, the image acquisition module 100 may be adhered to a rear surface of the front panel Ga. More specifically, a partial surface of a front surface of the image acquisition module 100 and a partial surface of the rear surface of the front panel Ga may be adhered to each other.

For reference, the image acquisition module 100 may include an image sensing device 170. The image acquisition module 100 may include a plurality of lighting devices 180 with the image sensing device 170. The plurality of lighting devices 180 increases the illuminance of the main storage space so that the image sensing device 170 acquires a clearer image. In the embodiment, the plurality of lighting devices 180 may include a first lighting part 180a and a second lighting part 180b. As another example, the image sensing device 170 or the plurality of lighting devices 180 may be omitted.

Referring to FIG. 5, a rear panel Gc of insulation panels Gb and Gc constituting a rear surface of the lower door 70 may be exposed rearward. The rear panel Gc may also include a window V. The window V of the rear panel Gc and the window V of the front panel Ga are successively disposed at a predetermined distance therebetween and assigned with the same reference numeral. Although no reference numeral is assigned, in the insulation panels Gb and Gc, the inner panel Gb unexposed outward of the lower door 70 may also have a window V.

Describing the door panel G with reference to FIG. 5, the door panel G may include 3 panels in total. The 3 panels may include the front panel Ga disposed at the foremost side, the inner panel Gb disposed in the lower door 70, and the rear panel Gc disposed at the rearmost side. Among the panels, the front panel Ga may be exposed forward (a front side of the main body 10 of the home appliance, X-axial direction in FIG. 1). The rear panel Gc may be exposed rearward (a rear side facing the lower storage space) on the contrary to the front panel).

The inner panel Gb and the rear panel Gc may constitute the insulation panels Gb and Gc. The inner panel Gb and the rear panel Gc may be stacked to each other at a constant distance. In addition, an empty space between the inner panel Gb and the rear panel Gc becomes a vacuum, thereby increasing insulation performance. As another example, the insulation panels Gb and Gc may include only the rear panel Gc without the inner panel Gb.

Installation regions T1 to T4 may be provided between the front panel Ga and the insulation panels Gb and Gc. The installation regions T1 to T4 may be provided in the empty space between the front panel Ga and the insulation panels Gb and Gc. The installation regions T1 to T4 may be a portion where the image acquisition module 100 and the connector module 200 are disposed. As another example, the insulation panels Gb and Gc are omitted, and the installation regions T1 to T4 may be disposed between the front panel Ga and the door frame 72, 77, 80, 90.

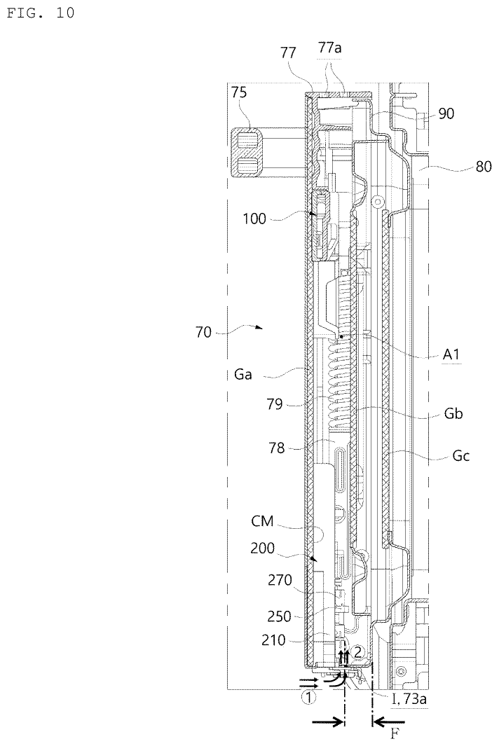

Referring to FIG. 10, a cooling flow path A1 may be provided between the front panel Ga and the insulation panels Gb and Gc. The cooling flow path A1 may be the entire space between the front panel Ga and the insulation panels Gb and Gc. The installation regions T1 to T4 may be disposed outside the window V with the window V as the center. Therefore, the cooling flow path A1 is wider than the installation regions T1 to T4, and the installation regions T1 to T4 may constitute a part of the cooling flow path A1.

Air may flow into the door panel G along the cooling flow path A1. Accordingly, the cooling flow path A1 may be a flowing space in which air flows.

As another example, the door panel G is not provided as a separate object, but may be a part of the door frame 72, 77, 80, 90. The door panel G may be integrally provided with the door frame 72, 77, 80, 90. In this case, the door panel G is not made of a transparent material and may shield the main storage space to prevent the main storage space from being exposed. The door panel G may be made of the same material as the door body. For example, the door panel G may have a metal or nonmetal plate structure.

In FIG. 4, the installation regions T1 to T4 are indicated. The installation regions T1 to T4 are portions where the image acquisition module 100 and the connector module 200 are disposed, and a dotted line in FIG. 4 is expressed to help understand the installation regions T1 to T4. In FIG. 4, the installation regions T1 to T4 are illustrated at the rear surface of the front panel Ga, but the installation regions T1 to T4 are actually provided in the empty space between the plurality panels and the door frame 72, 77, 80, 90.

Herein, the upper frame part 77 of the door frame 72, 77, 80, 90 may cover a part of an upper end of the rear surface of the front panel Ga. A part of the installation regions T1 to T4 may be formed in a portion not covered by the upper frame part 77. More specifically, in the installation regions T1 to T4, the first installation region T1, T3 may be provided at a lower portion of the upper frame part 77 that is not covered by the upper frame part 77.

The installation regions T1 to T4 may include (i) the first installation region T1, T3 formed in a first direction along an edge of the window V, and (ii) a second installation region T2, T4 formed in a second direction different from the first direction along an edge of the window V. In the embodiment, the first direction is a transverse direction (a transverse width direction of the lower door 70, Y-axial direction in FIG. 1), and the second direction is a vertical direction (a height direction of the lower door 70, Z-axial direction in FIG. 1).

The first installation region T1, T3 may be formed at each of an upper portion T1 and a lower portion T3 of the window V with the window V as the center. The second installation region T2, T4 may be formed at each side portion of the window V with the window V as the center. In other divisions, the installation region T1 to T4 may be divided into (i) the upper region T1 provided at the upper portion of the window V, (ii) the right region T2 provided at the right portion of the window V, (iii) the lower region T3 provided at the lower portion of the window V, and (iv) the left region T4 provided at the left portion of the window V. The division is based on FIG. 4.

The first installation region T1, T3 and the second installation region T2, T4 may be connected to each other. Opposite end portions of the first installation region T1, T3 and the opposite end portions of the second installation region T2, T4 are connected to each other. Accordingly, the installation regions T1 to T4 may be formed in connected spaces. Then, the image acquisition module 100 and the connector module 200 may be disposed to pass through the multiple installation regions T1 to T4.

In the embodiment, a main unit 100A, i.e., a part of the image acquisition module 100 may be disposed in the first installation region T1, T3. A part of a connection unit 100B, i.e., a remaining part of the image acquisition module 100 may be disposed in the second installation region T2, T4. The image acquisition module 100 and the connector module 200 may be electrically connected to each other through the door wire W2. In the embodiment, the connector module 200 is disposed in the second installation region T2, T4.

At least a part of the installation regions T1 to T4 may be provided at a region where a part of the door frame 72, 77, 80, 90 covers a rear surface of the front panel Ga. At this point, covering, by the rear frame part 80, a part of the image acquisition module 100 is based on the rear space of the lower door 70, i.e., a direction from the inside space of the main storage space to the rear surface of the lower door 70 when the lower door 70 is closed.

In the embodiment, the connector module 200 may be disposed in a part of the second installation region T2, T4, and a part of the first installation region T1, T3. FIG. 9 illustrates the connector module 200 disposed over the right side region T2 provided at the right side portion of the window V, and the lower region T3 provided at a lower portion of the window V Both the right side region T2 and the lower region T3 are provided outside the window V, so the regions may not be exposed outward.

As another example, the connector module 200 may be disposed at one of the regions including the upper region T1, the lower region T3, and the left side region T4. As another example, the connector module 200 does not extend to the lower region T3, and may be disposed in the right side region T2.

Preferably, considering the accessibility of the fabricator, one end portion of the connector module 200 may be disposed at an outer edge of the installation region T1 to T4. Then, the fabricator can easily access one end portion of the connector module 200 to assemble or maintain the connector module 200.

Meanwhile, the image acquisition module 100 is disposed in the first installation region T1, T3, and the door wire W2 for allowing signal transmission and power supply between the image acquisition module 100 and the main controller may be disposed in the second installation region T2, T4.

Herein, the front panel Ga may be divided into the window V, and an edge part disposed around the edges of the window V. Herein, the installation regions T1 to T4 may be provided on a rear surface of the edge part. At this point, the edge part may be processed to be opaque. Accordingly, the installation regions T1 to T4 provided at a lower surface of the edge part may not be exposed from the front space of the lower door 70, i.e., from the front space of the cooking appliance. The edge part may be formed by etching a part of the front panel Ga to increase the surface roughness, or by being coated with a separate film, or by being treated opaquely by a painting process.

Meanwhile, the upper frame part 77 may be disposed above an upper portion of the front opening 72c. The upper frame part 77 may be coupled to an upper portion of the front frame part 72, more specifically, to the upper ends of the pair of front side plates 72a. The upper frame part 77 may cover a part of an upper end of the rear surface of the front panel Ga. The image acquisition module 100 described below may be fixed to the upper frame part 77. Reference numerals 147 and 147′ indicate module fastening parts to which fasteners are coupled to fix the image acquisition module 100 to the upper frame part 77.

The frame outlet 77a may be open in the upper frame part 77. The frame outlet 77a may be an outlet through which air passing through the cooling flow path A1 formed in the lower door 70 is discharged outward. The frame outlet 77a may be connected to the installation regions T1 to T4 as described below.

Referring to FIG. 5, the lower door 70 may include a door hinge 78. The door hinge 78 may allow the lower door 70 to be connected to the main body 10 of the cooking appliance to be turned. The door hinge 78 may be disposed in the lower door 70, more specifically, in an empty space formed between the front frame part 72 and an inner frame part 90. A door hinge arm 78a may protrude on the door hinge 78. The hinge holding arm 78a passes through an inner hinge passage part 98 of the inner frame part 90 and a rear hinge passage part 88 of the rear frame part 80 in order, and then may be fixed by being caught by the main body 10 of the cooking appliance. Reference numeral 79 is a hinge spring 79 and may be fitted over a spring guide 78b of the door hinge 78. The hinge spring 79 may provide an elastic force to the door hinge 78 in a direction of closing the lower door 70 while being tensioned when the lower door 70 is opened.

With the door panel G located in the middle, the front frame part 72 may be disposed at the front of the door panel G, and the inner frame part 90 and the rear frame part 80 may be disposed at the rear of the door panel G. The inner frame part 90 and the rear frame part 80 are spaced apart from each other (i) to form an insulation space therebetween, and (ii) to fix the second insulation panels Gb and Gc. The inner frame part 90 is disposed between the rear frame part 80 and the front frame part 72, thereby being unexposed outward.

The rear frame part 80 may be roughly formed in a rectangular frame shape. When the lower door 70 is closed, the rear frame part 80 may face a front surface of the second cavity. The rear through part 81 may be open on a central portion of the rear frame part 80. The rear through part 81 may have a longitudinally open structure so that the internal space of the main storage space may be visible through the window V.

Rear side plates 82 may be provided at side surfaces of the rear frame part 80. The rear side plates 82 may be bent forward of the lower door 70. The rear side plates 82 may be disposed inside the front side plates 72a. Reference numeral 88 is the rear hinge passage part 88 through which the door hinge arm 78a of the door hinge 78 passes.

The rear frame part 80 may cover a part of the connector module 200. Accordingly, even when the user opens the lower door 70, the connector module 200 may not be exposed through the window V.

The inner frame part 90 may be coupled to the rear frame part 80. The inner frame part 90 may be formed roughly in a rectangular frame shape. When the lower door 70 is closed, the inner frame part 90 may stand vertically at a distance from the rear frame part 80. An inner through part 91 may be open on a central portion of the inner frame part 90. The inner through part 91 may have a longitudinally open structure so that the internal space of the main storage space may be visible through the window V.

Inner side plates 92 may be provided at side surfaces of the inner frame part 90. The inner side plates 92 may be bent forward of the lower door 70. The inner side plates 92 may overlap with the rear side plates 82. At the overlapped portions, the inner side plates 92 and the rear side plates 82 may be coupled to each other in a method such as welding, adhesion, or fastening by a separate fastener (not illustrated).

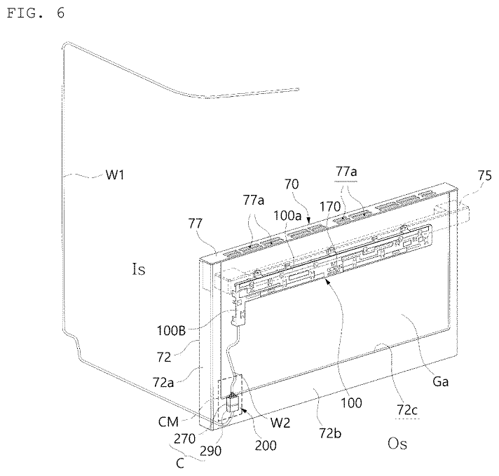

FIG. 6 illustrates the lower door 70 when viewed from the front space of the lower door 70. A wire to achieve power supply or signal transmission may be disposed in the main body 10 and the lower door 70 of the home appliance. The wire may include the main wire W1 to connect the connector module 200 of the lower door 70 to the main controller in the main body 10, and the door wire W2 to connect the connector module 200 to the image acquisition module 100.

When necessary, the fabricator can separate the main wire W1 from the connector module 200, and perform maintenance/repairing to the image acquisition module 100. For reference, FIG. 6 is a perspective view illustrating the image acquisition module 100. However, the image acquisition module 100 may be shielded by the edge part of the front panel Ga. FIG. 6 illustrates the door connector 270 constituting the connector module 200 assembled to the relative connector 290.

The connector module 200 may be disposed in the installation region T1 to T4 of the lower door 70. More specifically, the connector storage part CM may be provided in the installation region T1 to T4. The connector module 200 may be disposed in the connector storage part CM. The connector storage part CM may be an empty space, i.e., a part of the installation region T1 to T4. As another example, the connector storage part CM may be a kind of bracket integrated with the installation region T1 to T4, or provided as a separate object.

In FIG. 6, the connector storage part CM may be disposed close to a lower end portion of a side surface of the lower door 70. When the connector storage part CM is disposed at the lower end portion of the lower door 70, the fabricator may access the connector module 200 through the lower portion of the lower door 70. When the connector storage part CM is disposed at the lower end portion of the lower door 70, the connector module 200 may be prevented from being exposed outward normally. Furthermore, as described below, the connector inlet 73a of the connector storage part CM is open through the lower end portion of the lower door 70, so the fabricator can easily access the connector module 200.

As another example, the connector storage part CM may be disposed close to an upper end portion of a side surface of the lower door 70. Furthermore, the connector inlet 73a of the connector storage part CM may be open through the side surface of the lower door 70.

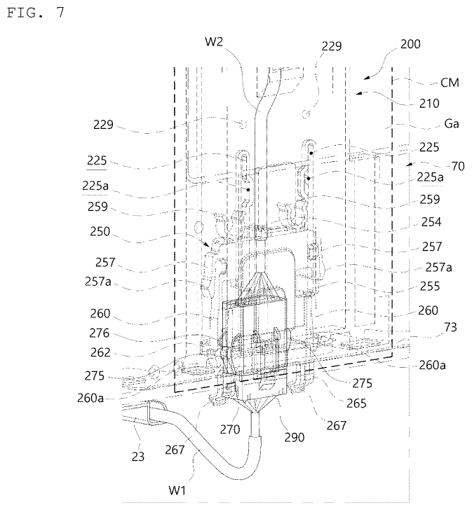

FIG. 7 illustrates the connector module 200 disposed in the connector storage part CM. Herein, the view illustrates the relative connector 290 separated from the door connector 270 of the connector module 200. The door connector 270 may be disposed at a lower end portion of the connector storage part CM. Accordingly, the relative connector 290 may be easily assembled to and separated from the door connector 270.

As illustrated in FIG. 7, the connector storage part CM may be disposed outside the window V. Accordingly, the connector storage part CM and the connector module 200 disposed in the connector storage part CM may not be exposed outward, or the exposed region may be minimized.

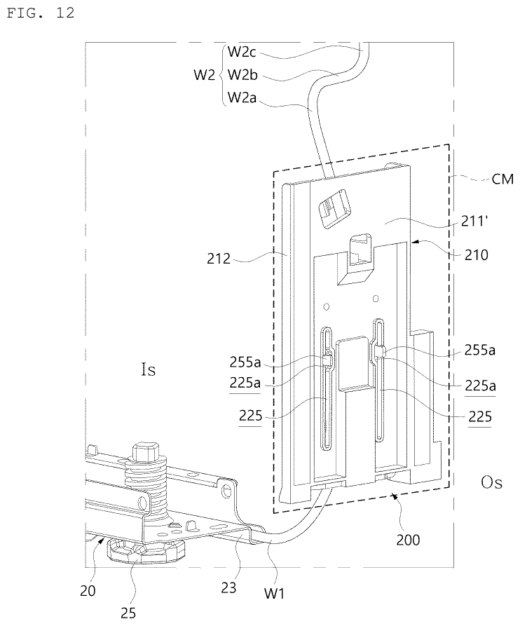

In FIG. 12, reference numeral 20 indicates a side frame 20 supporting a lower end of the main body 10. The side frame 20 may include a wire tube 23 guiding a mounting direction of the main wire W1. The main wire W1 may be disposed at a side surface of a lower portion of the main body 10 along the wire tube 23. Reference numeral 25 is a support leg to adjust the height of the main body 10.

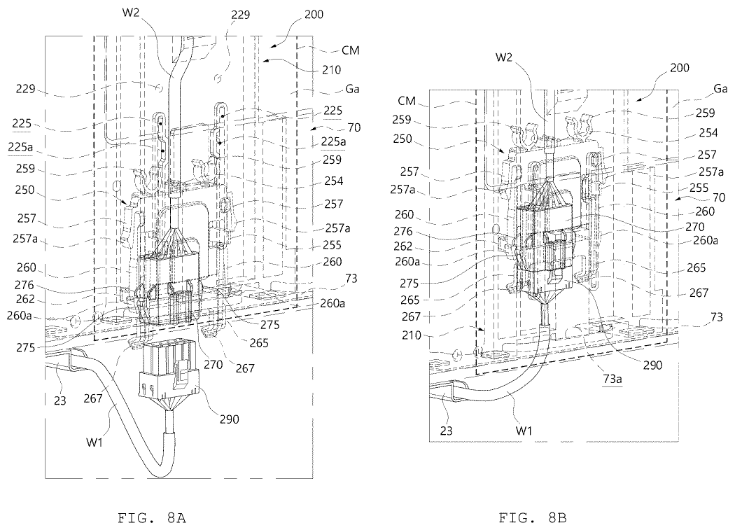

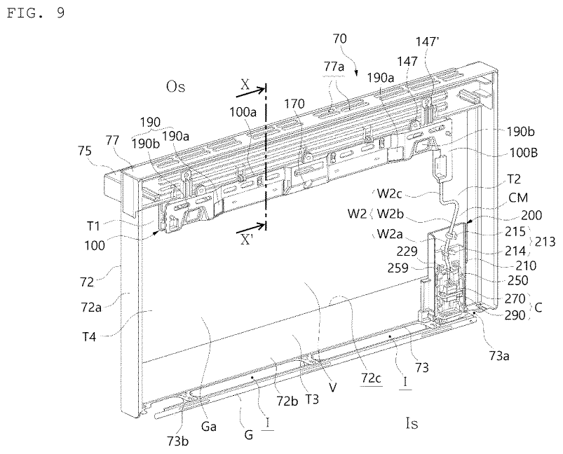

FIGS. 8A and 8B illustrate a process in which the door connector 270 disposed in the connector storage part CM is assembled with the relative connector 290. First, the door connector 270 may be moved to the operation position in the connector storage part CM. FIG. 8A illustrates the door connector 270 disposed at the operation position. Then, the relative connector 290 may be assembled to the door connector 270.

Herein, the door connector 270 is fixed to the operation position as described below, so the fabricator can prevent from separately gripping the door connector 270 when the fabricator assembles the relative connector 290 to the door connector 270. When the assembly of the door connector 270 and the relative connector 290 (hereinbelow, which will be referred to as a connector assembly C) are inserted into the connector storage part CM (upper side based on FIG. 7), the connector assembly C may be moved to the storage position. This state is illustrated in FIG. 8B.

For reference, the storage position is a position where the connector assembly C is moved to the inside part of the connector storage part CM not to be exposed outward. Furthermore, the operation position is a position where the door connector 270 is moved to the connector inlet 73a of the connector storage part CM to be assembled to/separated from the relative connector 290 and the assembly surface 271a of the door connector 270 is exposed outward. Herein, the storage position may be a first position, and the operation position may be a second position.

FIG. 9 illustrates the rear surface of the lower door 70. As illustrated in the drawing, the connector module 200 may be disposed in the lower portion of the side surface of the lower door 70. One end of the connector module 200 may be disposed in the lower end portion of the lower door 70. The connector module 200 may be disposed vertically, i.e., in the height direction of the lower door 70.

The lower frame part 73 may be provided at the lower end of the lower door 70. The connector inlet 73a of the connector storage part CM may be open in the lower frame part 73. As illustrated in FIG. 9, the connector inlet 73a may be formed by vertically penetrating the lower frame part 73. The connector inlet 73a may be a part of air inlets I, i.e., a plurality of inlets of the cooling flow path A1 which are open in the lower frame part 73. Reference numeral 73b indicates a bracket provided in the lower frame part 73 to mount the air guide AG. Furthermore, reference numeral 190 is a lighting cover to cover each lighting device 180.

The connector module 200 may include the door connector 270. The door connector 270 may be connected to a first end portion of the door wire W2. The first end portion of the door wire W2 may be coupled to the door connector 270, and a second end portion may be connected to the image acquisition module 100. FIG. 6 illustrates the second end portion of the door wire W2 connected to the image sensing device 170 of the image acquisition module 100. As another example, the second end portion of the door wire W2 may be connected to each lighting device 180. As another example, the second end portion of the door wire W2 may be connected to another electronic component such as the display device, etc.

The door connector 270 may be disposed in the connector storage part CM. The door connector 270 may be moved between the first position and the second position in the connector storage part CM. The first position may be the storage position. The second position may be the operation position. For reference, FIG. 9 illustrates the door connector 270 disposed at the storage position.

In the embodiment of the present disclosure, the door connector 270 is mounted to a movement supporter 250 and moved with the movement supporter 250. The movement supporter 250 may be mounted to the connector storage part CM. Herein, the movement supporter 250 may be moved along a mounting base 210 disposed in the connector storage part CM. As another example, the movement supporter 250 is omitted, and the door connector 270 may be directly disposed in the mounting base 210. The structures of the movement supporter 250 and the mounting base 210 will be described below.

FIG. 10 illustrates the connector storage part CM provided at the lower portion of the lower door 70. The connector storage part CM may be provided around a lower inlet of the cooling flow path A1. The door connector 270 may be disposed in the connector storage part CM. To move the door connector 270, there is a need to access the connector storage part CM. To this end, the connector inlet 73a may be open in the lower portion of the lower door 70.

Herein, the width of the connector inlet 73a may be larger than the thickness of the door connector 270. Herein, the width of the connector inlet 73a is based on the transverse direction of the lower door 70 and may be the transverse width based on FIG. 10. The thickness of the door connector 270 is based on the longitudinal direction of the lower door 70. When the width of the connector inlet 73a is larger than the thickness of the door connector 270, the connector inlet 73a may have a clearance. The clearance may be an operation space F. FIG. 10 illustrates the width of the operation space F. The fabricator may access the door connector 270 through the operation space F.

The operation space F may be formed between a surface of the door connector 270 and an edge of the connector inlet 73a. The operation space F may be an empty space between the surface of the door connector 270 and the inner frame part 90. The operation space F may be a space through which the fabricator can access the door connector 270 and an air inlet through which external air is introduced into the lower door 70 at the same time.

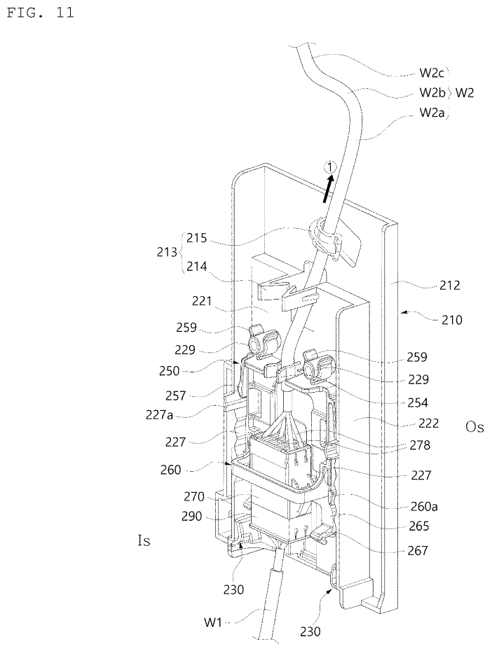

FIG. 11 illustrates an embodiment of the connector module 200. The connector module 200 may be disposed between the main wire W1 and the door wire W2. More specifically, the relative connector 290 to which the main wire W1 is connected may be connected to the door connector 270 to which the door wire W2 is connected, in the connector module 200. FIG. 11 illustrates the door wire W2 and the main wire W1 electrically connected to each other with the door connector 270 and the relative connector 290 assembled.

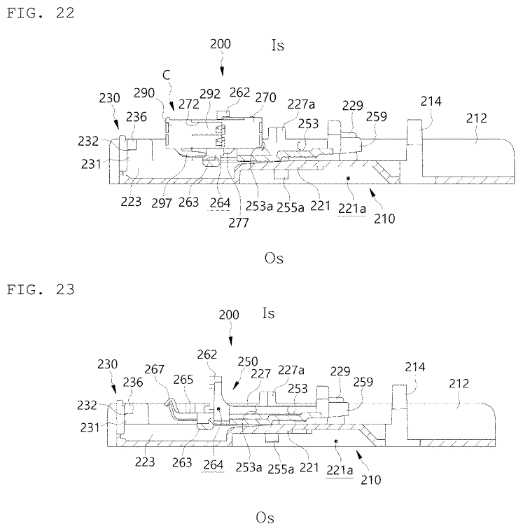

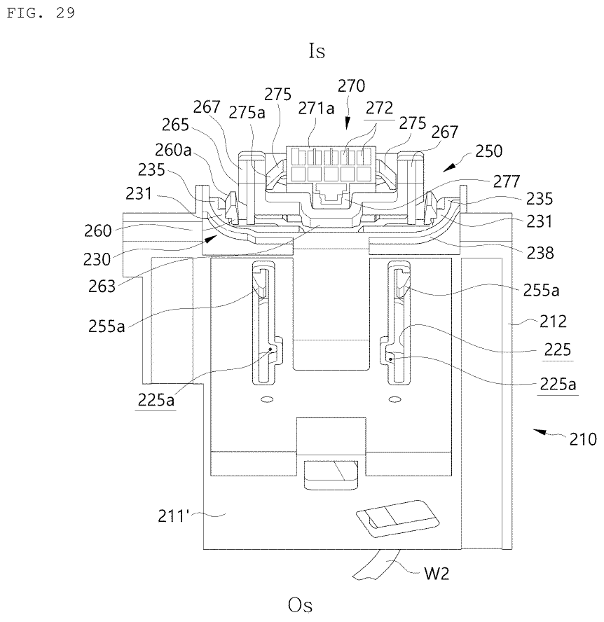

For convenience of description, describing the door connector 270 of the connector module 200 with reference to FIG. 20, the door connector 270 may have roughly a hexahedral structure. The door connector 270 may include a connector body 271 of an insulator in which a plurality of terminals (not illustrated) is disposed. Terminal wires 278 may be connected to the terminals. The terminal wires 278 may constitute the door wire W2. FIGS. 22 and 29 illustrate terminal holes 272 into which the terminals are inserted.

An assembly surface 271a may be provided on a front surface of the door connector 270. The assembly surface 271a may be a surface facing the connector inlet 73a. The assembly surface 271a may be a portion assembled with the relative connector 290.

A structure may be disposed on the surface of the door connector 270 to fix the door connector 270 to the movement supporter 250. Specifically, a connector lance part 275 may protrude on a surface of the door connector 270. The connector lance part 275 may pass through a mounting hole 264 provided in the movement supporter 250 and may be fixed by being caught by the opposite side of the mounting hole 264. Then, the door connector 270 is prevented from being separated in the opposite direction, i.e., an upward direction based on FIG. 20.

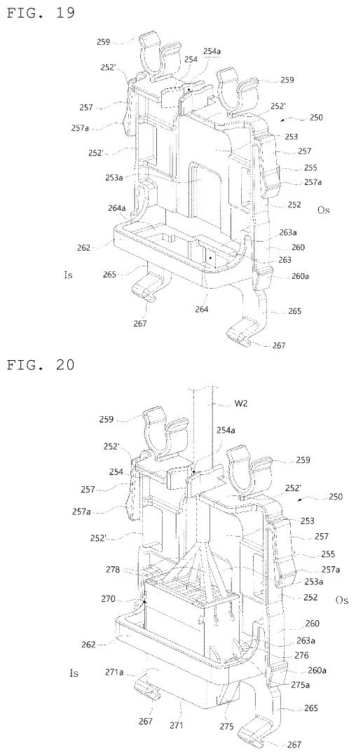

A connector protrusion 276 may be provided on a surface of the door connector 270. The connector protrusion 276 may fix the door connector 270 to the movement supporter 250. The connector protrusion 276 may be caught by a holding end portion 264a (referring to FIG. 19) provided at an edge of the mounting hole 264. When the connector protrusion 276 is caught by the holding end portion 264a, the door connector 270 is no longer moved in the mounting direction, i.e., in a downward direction based on FIG. 20. Eventually, the door connector 270 may be fixed in the opposite directions.

The connector module 200 may include the mounting base 210. The mounting base 210 may be fixed to the connector storage part CM. The mounting base 210 may guide the movement of the movement supporter 250 and the movement of the door connector 270. Since the mounting base 210 is fixed, the mounting base 210 may be moved relatively to the movement supporter 250 and the door connector 270. FIG. 11 illustrates the door connector 270 disposed at the storage position.

The mounting base 210 may guide the movement of the movement supporter 250 and the movement of the door connector 270. The mounting base 210 is fixed to the connector storage part CM, thereby preventing the movement supporter 250 and the door connector 270 from also being separated from the connector storage part CM. The mounting base 210 may guide an extension direction of the door wire W2 as described below.

Describing the mounting direction of the mounting base 210, as illustrated in FIG. 12, a rear surface of the mounting base 210 may face the front space of the lower door 70. When viewed from the front space of the lower door 70, the movement supporter 250 and the door connector 270 disposed on the front surface of the mounting base 210 may be covered by the mounting base 210. Of course, since the connector module 200 including the mounting base 210 is disposed outside the window V, the connector module 200 may be covered by an edge portion of the lower door 70.

As another example, the mounting base 210 may cross a portion of the window V, but a lower surface of the mounting base 210 has a flat surface structure, and the mounting base 210 may cover both the door connector 270 and the movement supporter 250, so the mounting base 210 may be partially exposed to external space (front space of the lower door 70.

The door wire W2 may extend upward of the mounting base 210. The main wire W1 may extend downward of the mounting base 210. The mounting base 210 is disposed closer to the wire tube 23 provided in the side frame 20, so an exposure area of the main wire W1 may be reduced.

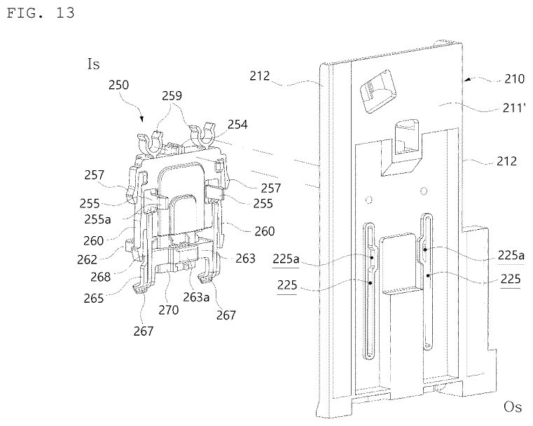

Referring to FIG. 13, the movement supporter 250 and the door connector 270 may be separated from the mounting base 210. When the movement supporter 250 is mounted to the mounting base 210, the movement supporter 250 may be linearly moved along the mounting base 210. The movement supporter 250 may be separated from the mounting base 210 or assembled with the mounting base 210 only at a specific position. This structure will be described below.

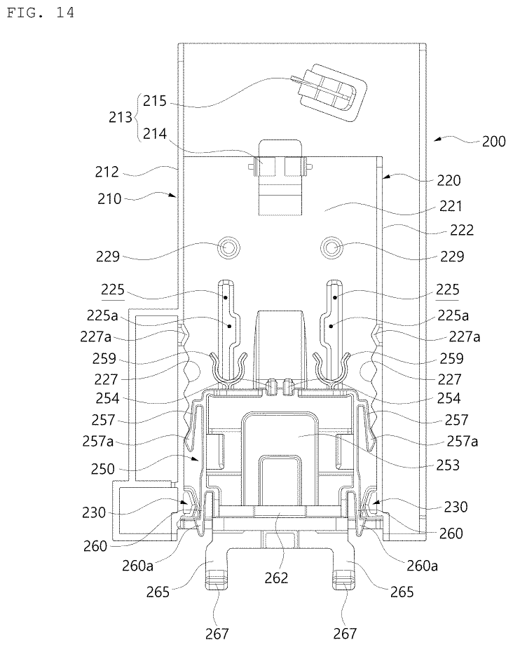

FIG. 14 illustrates the movement supporter 250 mounted to the mounting base 210. For reference, FIG. 14 illustrates the movement supporter 250 in the operation position. As illustrated in the drawing, a vertical height of the mounting base 210 in a movement direction of the movement supporter 250 may be formed wider than a transverse width perpendicular to the vertical height. The transverse width of the mounting base 210 may be formed smaller than or equal to the width of the installation region T1 to T4. Accordingly, the mounting base 210 may not be separated from the installation region T1 to T4.

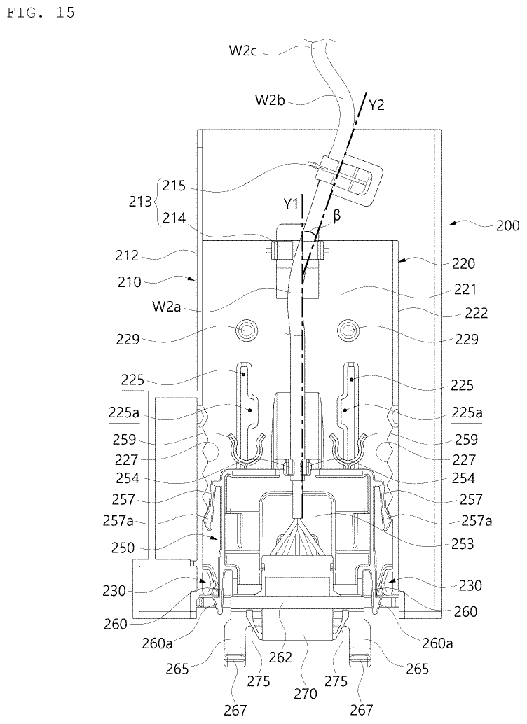

FIG. 15 illustrates the assembly of the movement supporter 250 and the door connector 270, the assembly being mounted to the mounting base 210. FIG. 15 illustrates the structure of the connector module 200 based on a direction from the inside part of the storage space toward the lower door 70. As described above, the mounting base 210 does not completely cover the movement supporter 250 and the door connector 270, but may expose the movement supporter 250 and the door connector 270. However, the connector module 200 is disposed in the connector storage part CM provided in the door, thereby being prevented from being visible from the outside space.

FIG. 16 illustrates the connector module 200 illustrated in FIG. 15 with the relative connector 290 assembled. In FIG. 16, the door connector 270 and the relative connector 290 are in the operation position. In the operation position, the door connector 270 may be assembled with or separated from the relative connector 290. When the relative connector 290 is pushed upward from the state illustrated in FIG. 16, the door connector 270 and the movement supporter 250 may be moved with the relative connector 290. Then, the door connector 270, the relative connector 290, and the movement supporter 250 may be moved to the storage position.

Herein, the door connector 270 may be moved in a constant section with the movement supporter 250. As described below, a mounting stopper 229 provided in the mounting base 210 may interfere with a stopping holder 259 of the movement supporter 250 to limit a movement range of the movement supporter 250. More specifically, the mounting stopper 229 may limit the depths at which the movement supporter 250 and the door connector 270 are inserted.

The mounting base 210 may include a restraint maintaining part 230 provided at the opposite side of the mounting stopper 229. When the movement supporter 250 and the door connector 270 are moved to the operation position, the restraint maintaining part 230 may enable the movement supporter 250 and the door connector 270 to be fixed without being separated from the operation position. A detailed structure of the restraint maintaining part 230 will be described below again.

As illustrated in FIG. 16, a part of the door connector 270 disposed in the operation position may protrude outside the connector inlet 73a. In the drawing, CH1 indicates the entire length of the connector assembly C. The sum of the length of a part of the door connector 270 protruding outside the connector inlet 73a and the length of the relative connector 290 is indicated as CH2.

Herein, the sum CH1 of the length of the door connector 270 and the length of the relative connector 290 may be smaller than or equal to a distance X1 from a lower end of the mounting base 210, i.e. the operation position, to the mounting stopper 229. Accordingly, the entire connector assembly C may be completely seated on the mounting station 220. The distance X1 from the lower end of the mounting base 210 to the mounting stopper 229 may be longer than the length of the movement supporter 250.

The sum CH2 of the length of the part of the door connector 270 protruding outward of the connector inlet 73a and the length of the relative connector 290 may be shorter than or equal to a movement range X2 of the door connector 270. Then, when the connector assembly C is moved to the storage position, the relative connector 290 is also moved to the storage position to prevent the entire connector assembly C from being exposed outward. In other words, when the connector assembly C is moved to the storage position, the relative connector 290 is also moved to the storage position so that the entire connector assembly C may be disposed above the lower end of the mounting base 210.

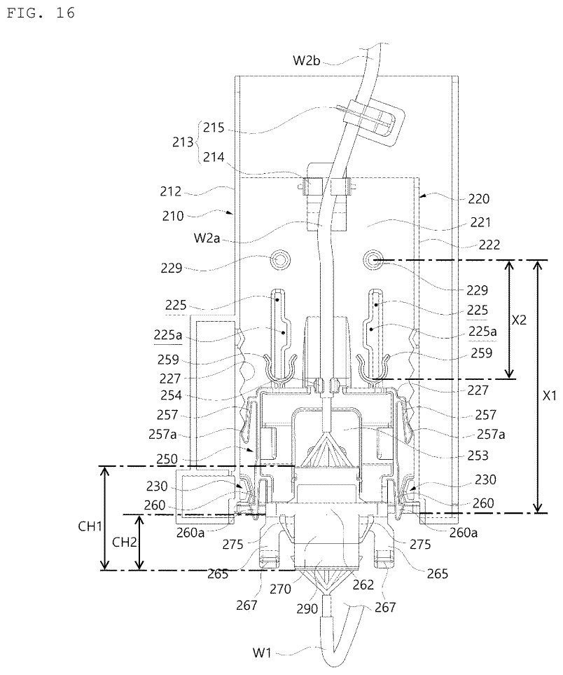

FIG. 17 illustrates the connector assembly C and the movement supporter 250 in the storage position. As illustrated in the drawing, a lower end of the relative connector 290 may be disposed above the lower end of the mounting base 210. Therefore, the relative connector 290 may be prevented from protruding outward of the connector inlet 73a. On the other hand, the movement supporter 250 is no longer moved in the upward direction based on FIG. 17, due to interference with the mounting stopper 229.

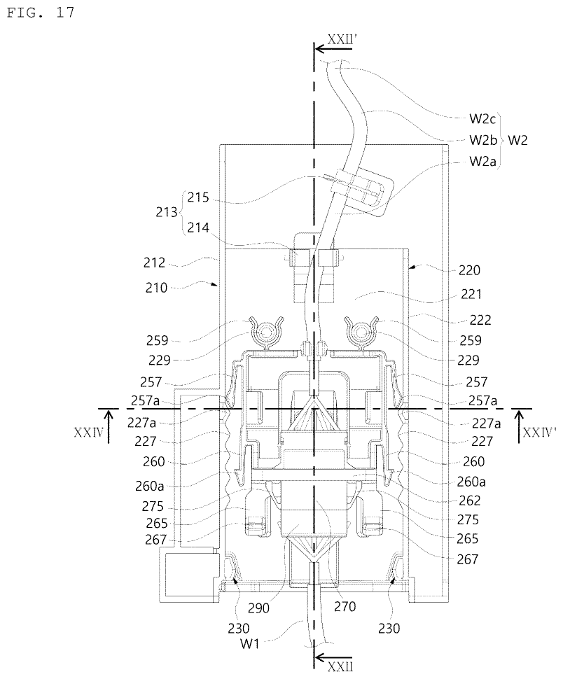

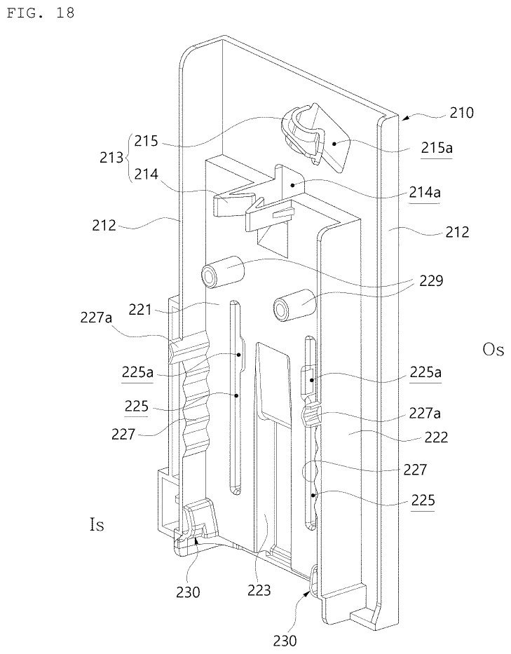

The structure of the mounting base 210 will be described in detail with reference to FIG. 18. A frame of the mounting base 210 may be formed of a base body 211 of a flat plate structure. The mounting station 220 may be disposed on a first surface of the base body 211. A second surface 211′ of the base body 211 (referring to FIG. 13) may be brought into close contact with a surface of the front panel. For example, the second surface 211′ of the base body 211 may adhere to the surface of the front panel as a fixation surface. As another example, the base body 211 may be fixed to the door frame 72, 77, 80, 90, not a surface of the front panel.

A guide fence 212 may be provided at either side of the base body 211. The guide fence 212 may stand outside the mounting station 220. The guide fence 212 may be provided in a movement direction of the door connector 270 outside the mounting station 220. In the embodiment, the guide fence 212 is provided at either side of the mounting station 220. As another example, the guide fence 212 may be provided only on either side of the mounting station 220 or may be omitted.

The guide fence 212 may form a movement path of the movement supporter 250 and the door connector 270 with an inner fence 222 described below. The guide fence 212 and the inner fence 222 may guide the movement of the movement supporter 250 and the door connector 270. The inner fence 222 may be adjacent to the mounting station 220 and provided along a side surface of the mounting station 220. The inner fence 222 may be a part of the guide fence 212.

The base body 211 may include a wire guide 213. The wire guide 213 may guide a direction in which the door wire W2 extends. The wire guide 213 may protrude from the base body 211. The wire guide 213 may be disposed between the image acquisition module 100 and the door connector 270. The wire guide 213 covers the door wire W2 so that the door wire W2 extends in a preset direction. In the embodiment, since the door connector 270 is moved, a relative distance between the door connector 270 and the fixed wire guide 213 may change.

The base body 211 may include a plurality of wire guides 213. The plurality of wire guides 213 may be provided in an extension direction of the door wire W2. In the embodiment, the plurality of wire guides 213 may include a first guide 214 and a second guide 215.

The first guide hole 214a of the first guide 214 and the second guide hole 215a of the second guide 215 may be open in different directions. The first guide hole 214a may be open in the movement direction of the movement supporter 250. The second guide hole 215a may be open in a direction different from the movement direction of the movement supporter 250. In the embodiment, the second guide hole 215a is open in a direction biasing toward the edge of the door body.

A seating surface 221 may be formed on a surface of the mounting station 220. The seating surface 221 may be a surface on which the movement supporter 250 slides on the surface of the mounting station 220. Since the mounting station 220 is a protruding portion of the base body 211, the seating surface 221 may be formed higher than other portions of the base body 211.

The seating surface 221 may include a supporter guide groove 223. The supporter guide groove 223 may be recessed from the seating surface 221. The supporter guide groove 223 may guide sliding of the movement supporter 250. A guide block 253a of the movement supporter 250 (referring to FIG. 22) may be inserted into the supporter guide groove 223 and the guide block 253a will be described below. While the guide block 253a is inserted into the supporter guide groove 223, the movement supporter 250 may be moved. Therefore, the supporter guide groove 223 may guide the movement of the movement supporter 250 in a constant direction. As another example, the supporter guide groove 223 may be omitted.

The seating surface 221 may include a guide slot 225. The guide slot 225 may be formed longitudinally through the seating surface 221. The guide slot 225 may be provided at either side of the supporter guide groove 223 with the supporter guide groove 223 as the center. A guide arm 255 of the movement supporter 250 may be inserted into each guide slot 225, and the guide arm 255 will be described below. While the guide arm 255 is inserted into the guide slot 225, the movement supporter 250 may slide on the seating surface 221. Therefore, the guide arm 255 may guide the movement of the movement supporter 250 in a constant direction with the supporter guide groove 223. As another example, one guide slot 225 and one guide arm 255 may be provided.

Herein, a direction in which the guide arm 255 is inserted into the guide slot 225 may be a first direction. A direction in which the guide arm 255 guides the movement of the movement supporter 250 with the supporter guide groove 223 may be a second direction. Herein, the first direction and the second direction may be different from each other. For example, the first direction and the second direction may be perpendicular to each other. As another example, the first direction may oppose the second direction.

The guide slot 225 may include a slot entrance 225a. The slot entrance 225a may be a portion where the width of the guide slot 225 is widened. A guide head 255a of the guide arm 255 may be inserted into the slot entrance 225a. The guide head 255a may have a thicker portion than other portions of the guide arm 255. Therefore, after the guide head 255a is inserted into the slot entrance 225a, when the movement supporter 250 is moved from the slot entrance 225a, the guide head 255a is caught by the guide slot 225 not to be separated.

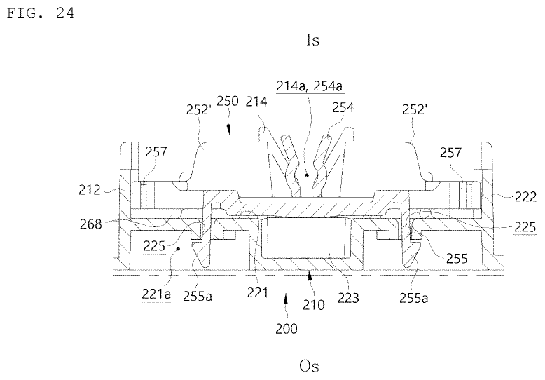

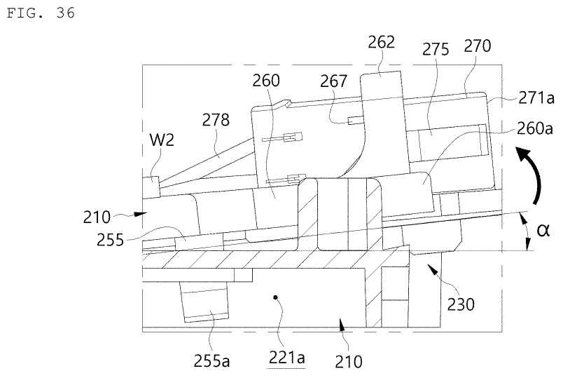

Referring to FIGS. 24 and 36, the guide head 255a and an edge of the guide slot 225 are spaced apart from each other, so a spacing may be provided therebetween. The spacing may prevent the guide head 255a from interfering with the edge of the guide slot 225 when the entire movement supporter 250 is turned. The movement supporter 250 may be relatively turned in a direction of reducing the spacing with respect to the mounting base 210.

A first position fixation part 227 may be provided at either side of the seating surface 221. The first position fixation part 227 may constitute a storage fixation part 227, 257 with a second position fixation part 257 described below. The first position fixation part 227 may interfere with the movement supporter 250 to fix the movement supporter 250 and the connector assembly C to the storage position. When the movement supporter 250 and the connector assembly C are fixed to the storage position by the storage fixation part 227, 257, the movement supporter 250 and the connector assembly C are not returned to the operation position, and may remain fixed to the connector storage part CM.

The storage fixation part 227, 257 may be continuously or discontinuously disposed in the movement direction of the door connector 270. When the storage fixation part 227, 257 is continuously provided in the movement direction of the door connector 270, the movement supporter 250 and the connector assembly C may be fixed to a plurality of storage positions in phases. When the storage fixation part 227, 257 is discontinuously provided in the movement direction of the door connector 270, the movement supporter 250 and the connector assembly C may be fixed to a limited specific storage position.

The storage fixation part 227, 257 may include the first position fixation part 227 and the second position fixation part 257. The first position fixation part 227 may be provided in the mounting base 210 of the connector module 200. The second position fixation part 257 may be provided in the movement supporter 250 or the door connector 270. The second position fixation part 257 may be engaged with the first position fixation part 227. When the second position fixation part 257 is engaged with the first position fixation part 227, the second position fixation part 257 may remain caught by and fixed to the first position fixation part 227.

Referring to FIG. 17, the first position fixation part 227 may be continuously provided along the guide fence 212. The first position fixation part 227 may have an uneven structure. The first position fixation part 227 may be configured by repeatedly arranging a structure protruding in a central direction of the seating surface 221, i.e., a central direction of the movement supporter 250, and a structure recessed in the opposite direction. For example, the first position fixation part 227 may have a sawtooth structure. The first position fixation part 227 of the sawtooth structure may form a kind of multistep structure. The second position fixation part 257 may be fixed to a portion of a plurality of positions of the first position fixation part 227 of the multistep structure. Accordingly, the movement supporter 250 may have a plurality of storage positions. In other words, in the embodiment, the storage fixation part 227, 257 may have a kind of a free stop structure.

The storage fixation part 227, 257 may include a pair of first position fixation parts 227. The pair of first position fixation parts 227 may be disposed to face each other. The pair of first position fixation parts 227 may be engaged with a pair of second position fixation parts 257 provided in the movement supporter 250.

Referring to FIG. 18, each first position fixation part 227 may include a storage locking end 227a. The storage locking end 227a may be disposed at the innermost portion in the storage position. In the embodiment, based on the drawing, the storage locking end 227a may be disposed at the uppermost end of the first position fixation part 227. When the second position fixation part 257 is caught by the storage locking end 227a, the movement supporter 250 and the connector assembly C may be stored in the deepest position in the connector storage part CM. This figure as described above is illustrated in FIG. 17.

The storage locking end 227a may further protrude than other portions of the first position fixation part 227. When a protruding length of the storage locking end 227a is relatively longer than other portions, the movement supporter 250 disposed at the uppermost storage position may be prevented from a guide fence may stand at either side from the first position fixation part 227 when being moved to the operation position. When the movement supporter 250 disposed at the storage position in the uppermost end is pulled and moved, the greatest force is generated. Herein, the second position fixation part 257 of the movement supporter 250 may deviate from the first position fixation part 227. However, in the embodiment, the storage locking end 227a extends long, so the second position fixation part 257 may stay in the storage locking end 227a even when deviating.

The storage locking end 227a may be provided on a first end portion of the first position fixation part 227. A distance from the storage locking end 227a to a second end portion of the first position fixation part 227 may be the entire length of the first position fixation part 227. The entire length of the first position fixation part 227 may be longer or equal to the movement distance of the movement supporter 250 and the connector assembly C. Accordingly, in the process in which the movement supporter 250 and the connector assembly C are moved, the second position fixation part 257 may be continuously engaged with the first position fixation part 227.

In the embodiment, the second position fixation part 257 has an elastic deformable structure. Therefore, the second position fixation part 257 may be elastically deformed in the process in which the second position fixation part 257 is engaged with the first position fixation part 227. As another example, the first position fixation part 227 may have an elastic deformable structure. The first position fixation part 227 has a cantilever structure, and the movement supporter 250 may be moved with the second position fixation part 257 elastically deforming the first position fixation part 227.

As another example, the storage fixation part 227, 257 may have a structure in which the movement supporter 250 is press-fitted into the mounting base 210, not the elastic deformation structure. As another example, the movement supporter 250 may be assembled to the storage fixation part 227, 257 to be turned, or have a latch structure. Otherwise, the movement supporter 250 may be fixed to the mounting base 210 through a separate fastener.

The mounting station 220 may include the mounting stopper 229. The mounting stopper 229 may interfere with the movement supporter 250 to limit the movement range of the movement supporter 250. The mounting stopper 229 may be provided with a cantilever structure in the mounting station 220. The mounting stopper 229 may have a cylindrical shape. The mounting stopper 229 may be disposed between the first guide 214 and the guide slot 225.

The mounting stopper 229 may interfere with the stopping holder 259 of the movement supporter 250. When the stopping holder 259 is brought into contact with the mounting stopper 229, the movement supporter 250 can no longer be moved. The figure as described above is illustrated in FIG. 17. The stopping holder 259 may be caught in a shape covering a surface of the mounting stopper 229. In the embodiment, a pair of mounting stoppers 229 may be provided. As another example, the mounting stopper 229 may include one mounting stopper or three or more mounting stoppers.

The mounting base 210 may include the restraint maintaining part 230 at the opposite side of the mounting stopper 229. The restraint maintaining part 230 may enable the movement supporter 250 and the door connector 270 to remain fixed to the operation position. The restraint maintaining part 230 may fix the movement supporter 250 fixed to the operation position, and prevent the movement supporter 250 from being moved toward the storage position. A detailed structure of the restraint maintaining part 230 will be described below again.

The movement supporter 250 will be described with reference to FIGS. 19 and 20. The door connector 270 may be mounted to the movement supporter 250. The door connector 270 may be moved along the mounting station 220 with the movement supporter 250. The movement supporter 250 may be moved between the storage position and the operation position. The movement supporter 250 may remain fixed to the storage position and the operation position respectively.

A plurality of surfaces of the movement supporter 250 may be brought into close contact with a plurality of different surfaces of the mounting base 210. Then, the movement supporter 250 may be linearly moved while being stably seated on the mounting base 210. In the embodiment, the movement supporter 250 may maintain a state in close contact with the mounting base 210 at a lower surface, i.e., a surface facing the mounting station 220, and both side surfaces facing the first position fixation part 227. Accordingly, the movement supporter 250 may be operated while being supported by the mounting base 210 in at least three different portions.

A frame of the movement supporter 250 may be formed of a supporter body 251. The supporter body 251 may have a flat plate structure. A first surface of the supporter body 251 may be a supporting board 253 on which the door connector 270 is seated. A second surface of the supporter body 251 may be brought into close contact with the seating surface 221 of the mounting base 210. The entire length of the supporter body 251 (a vertical length based on the drawing) may be shorter than or equal to the length of the mounting station 220.

The supporter body 251 may include a supporter fence 252. The supporter fence 252 may protrude while surrounding an edge of the supporter body 251. The supporter fence 252 may form a connector mounting space on one surface of the supporter body 251. An upper fence 252′ may be provided on an upper end of the supporter body 251. The upper fence 252′ may protrude more than the supporter fence 252.

The supporter body 251 may include the supporting board 253. The supporting board 253 may be disposed in a central portion of the surface of the supporter body 251. The door connector 270 may be seated on the supporting board 253. In the mounting process of the door connector 270, the door connector 270 may be assembled to a connector holder 262 while sliding on the supporting board 253.

The guide block 253a may be disposed in the supporting board 253. The guide block 253a may be recessed suitable to the shape of the door connector 270. On the other hand, the guide block 253a may protrude on a second surface of the supporting board 253. While the guide block 253a is inserted into the supporter guide groove 223, the movement supporter 250 may be moved. When the door connector 270 is mounted to the supporter body 251, the guide block 253a may guide the movement of the door connector 270.

Herein, the vertical length of the supporting board 253 may be longer than the vertical length of the door connector 270. Herein, the vertical length may be equal to the movement direction of the movement supporter 250. The door connector 270 may slide downward while being seated on an upper portion of the supporting board 253 to be mounted to the connector holder 262 described below. Therefore, the length of the supporting board 253 is preferably longer than the length of the door connector 270.

The supporter body 251 may include the wire fixation part 254. The wire fixation part 254 may guide a direction in which the door wire W2 connected to the door connector 270 extends. The wire fixation part 254 may have a kind of clip structure. The wire fixation part 254 may have a clip structure to fix the door wire W2 while covering both side portions thereof. In the embodiment, the wire fixation part 254 may be provided in a central portion of the upper fence 252′. A wire fixation hole 254a is open in a central portion of the wire fixation part 254, so the door wire W2 may pass through the wire fixation hole.

The wire fixation part 254 may be disposed on a vertical line Y1 same as the first guide 214. FIG. 15 illustrates the wire fixation part 254 disposed on the extension line Y1 same as the first guide 214. The wire fixation part 254 and the second guide 215 are not disposed on the same extension line Y1. Accordingly, the door wire W2 may extend vertically, i.e., in the movement direction of the movement supporter 250 and the door connector 270, while passing through the wire fixation part 254 to the first guide 214.

A first portion W2a of the door wire W2 that passes through the first guide 214 may pass through the second guide 215 and deviate from the extension line Y1 to be guided in a direction of an extension line Y2 biasing to one side. For reference, FIG. 24 illustrates the wire fixation hole 254a of the wire fixation part 254 and the first guide hole 214a of the first guide 214 aligned concentrically. In the embodiment, the imaginary extension line Y1 between the wire fixation part 250 and the first guide 214 and the imaginary second extension line Y2 connecting the first guide 214 to the second guide 215 may form an acute angle therebetween.

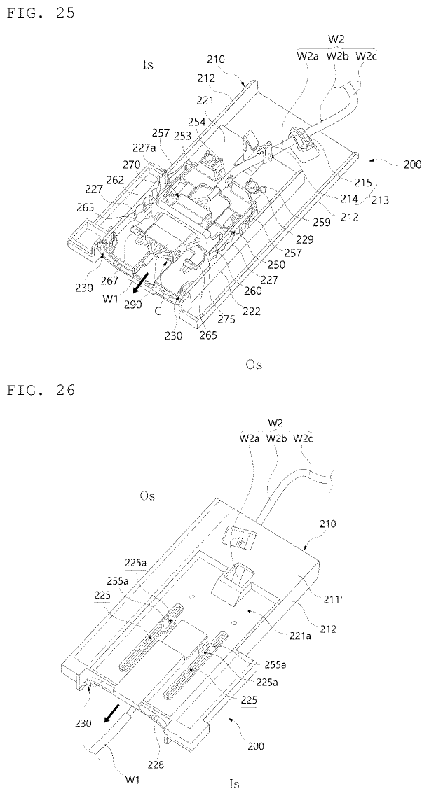

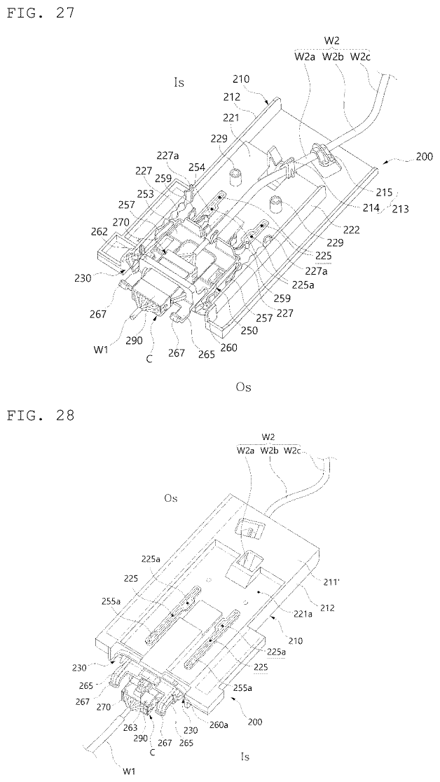

Comparing FIGS. 25 and 27, when the movement supporter 250 and the door connector 270 are located in the storage position (FIG. 25), the door wire W may be pushed toward the image acquisition module 100 (an upward direction based on the drawing) to be partially bent. Herein, a part of the door wire W2 between the first guide 214 and the second guide 215 may be referred to as the first portion W2a, and a part of the door wire W2 that passes through the second guide 215 may be referred to as a second portion W2b.

As illustrated in FIG. 25, when the door wire W is pushed toward the image acquisition module 100 (upward direction based on the drawing), a part that passes through the second portion W2b may be naturally bent, and the portion may be referred to as a third portion W2c. The extension direction of the door wire W to the second portion W2b may be fixed by the second guide 215. The second guide 215 may induce the second portion W2b in a direction far away from the window V, i.e., toward the edge of the door body. Therefore, even when the third portion W2c is bent, the door wire does not cross the window V.

On the other hand, as illustrated in FIG. 27, when the movement supporter 250 is moved to the operation position, the door wire W is unfolded and recovered from the bent state of the third portion W2c. Eventually, the second guide 215 may induce the portion where the bending of the door wire W starts to be moved as far away from the window V as possible.

The supporter body 251 may include the guide arm 255. The guide arm 255 may protrude from the surface of the supporter body 251 toward the seating surface 221 of the mounting base 210. The guide arm 255 may be inserted into the guide slot 225. When the guide arm 255 passes through the guide slot 225, the guide arm 255 is prevented from being separated from the mounting base 210. The guide arm 255 is moved along the guide slot 225, so the movement of the guide arm may be guided by the guide slot 225.

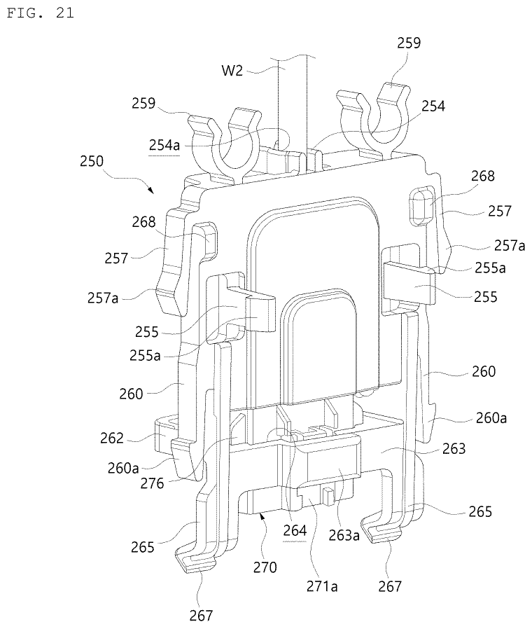

Referring to FIG. 21, one end of the guide arm 255 may include the guide head 255a. The guide head 255a may prevent the guide arm 255 from being removed from the guide slot 225. The guide head 255a may pass through the guide slot 225 through the slot entrance 225a of the guide slot 225. Since the thickness of the guide head 255a is thicker than other portions of the guide arm 255, when the guide arm 255 is moved along the guide slot 225 after passing through the slot entrance 225a, the guide arm 255 is prevented from being removed from the guide slot 225.

Referring to FIGS. 19 and 20, the supporter body 251 may include the second position fixation part 257. The second position fixation part 257 may be caught by the first position fixation part 227, thereby fixing a position of the movement supporter 250. The second position fixation part 257 may extend into a cantilever shape from the supporter body 251. The second position fixation part 257 may be an elastic fixation arm having a cantilever shape in which a first end portion is a fixation end fixed on the surface of the supporter body 251 and a second end portion is a free end. Accordingly, the second position fixation part 257 may be elastically deformed in the interference process with the first position fixation part 227. For the elastic deformation, the free end of the second position fixation part 257 may have a spreading form spaced apart from the surface of the supporter body 251. In the embodiment, the second position fixation part 257 may be provided into a cantilever shape on either side surface of the supporter body 251.

One end of the second position fixation part 257 may include a fixation end portion 257a. The fixation end portion 257a may be a portion relatively thicker than other portions in the second position fixation part 257. The fixation end portion 257a may be fixed by being caught by the first position fixation part 227 of the uneven shape. The fixation end portion 257a may have a shape engaged with the gear shape structure of the first position fixation part 227.

The movement supporter 250 may include the stopping holder 259. The stopping holder 259 may interfere with the mounting stopper 229 provided on the mounting base 210, thereby limiting the movement range of the movement supporter 250. The stopping holder 259 may be provided on the upper end of the supporter body 251. More precisely, the stopping holder 259 may protrude upward from a surface of the upper fence. The stopping holder 259 may have a shape generally resembling a clip. In the embodiment, the movement supporter 250 may include the stopping holder 259 on either portion of the wire fixation part 254 with the wire fixation part 254 as the center. As another example, only one stopping holder 259 may be provided, or the stopping holder 259 may be omitted. When the stopping holder 259 is omitted, the surface of the movement supporter 250 may directly interfere with the mounting stopper 229.

The stopping groove (not assigned with reference numeral) may be formed inside the stopping holder 259. A part of an upper end of the stopping groove may be open. The mounting stopper 229 may be inserted through the open portion. The stopping groove may cover the surface of the mounting stopper 229 provided on the mounting base 210. Accordingly, the mounting stopper 229 may limit the depth at which the movement supporter 250 and the door connector 270 are inserted.

The movement supporter 250 may include a supporter restraint arm 260. The supporter restraint arm 260 may protrude from the movement supporter 250. The supporter restraint arm 260 may have a cantilever structure in which a first end portion is a fixation end portion fixed to a side surface of the supporter body 251 and a second end portion is a free end portion. Therefore, the supporter restraint arm 260 may be elastically deformed. Herein, for the elastic deformation, the free end portion of the supporter restraint arm 260 may have a spreading structure spaced apart from the side surface of the movement supporter 250. The supporter restraint arm 260 may be fixed to the restraint maintaining part 230 of the mounting base 210. When the supporter restraint arm 260 is fixed to the restraint maintaining part 230, the movement supporter 250 and the connector assembly C may remain fixed to the operation position.

Reference numeral 260a is a restraint head 260a provided at the supporter restraint arm 260. The restraint head 260a may be a portion substantially caught by the restraint maintaining part 230 and fixed. The supporter restraint arm 260 including the restraint head 260a may have a kind of hook structure.

Referring to FIG. 17, a distance of the supporter restraint arm 260 protruding from the side surface of the movement supporter 250 may be shorter than the second position fixation part 257. In other words, the second position fixation part 257 may protrude in a direction further spreading from the side surface of the movement supporter 250 than the supporter restraint arm 260. Then, the supporter restraint arm 260 may be prevented from interfering with the first position fixation part 227 in the movement process of the movement supporter 250.

The movement supporter 250 may include the connector holder 262. The connector holder 262 may fix the door connector 270 to the movement supporter 250. In other words, the connector holder 262 may enable the movement supporter 250 to transfer the door connector 270. The connector holder 262 may be provided below the supporting board 253. The connector holder 262 may have roughly a kind of rectangular frame structure surrounding a surface of the door connector 270. The mounting hole 264 is provided in a central portion of the connector holder 262, and the door connector 270 may be disposed in the mounting hole 264.

The connector holder 262 may include a connector support end 263. The connector support end 263 may make the mounting hole 264 with the connector holder 262. The connector support end 263 may be disposed below the guide block 253a. When the connector holder 262 surrounds a first surface and both side surfaces of the door connector 270, the connector support end 263 may support a second surface of the door connector 270. Reference numeral 263a indicates a support end recessed part that is recessed to match the shape of the door connector 270.

Referring to FIG. 20, when the door connector 270 is mounted to the mounting hole 264, the connector lance part 275 of the door connector 270 may pass through the mounting hole 264 and be fixed by being caught by the opposite side portion of the mounting hole 264. Then, the door connector 270 is prevented from being separated in the opposite direction, i.e., an upward direction based on FIG. 20.

An edge portion of the mounting hole 264 may include a holding end portion (referring to FIG. 19). The holding end portion 264a may be a portion by which the connector protrusion 276 of the door connector 270 is caught. When the connector protrusion 276 is caught by the holding end portion 264a, the door connector 270 is no longer moved in the mounting direction, i.e., in a downward direction based on FIG. 20. Eventually, the door connector 270 may be fixed in the opposite directions.

The movement supporter 250 may include an operation lever 265. The operation lever 265 may be a portion that is operated to remove the state where the movement supporter 250 is caught the restraint maintaining part 230 of the mounting base 210. When the restraint head 260a of the supporter restraint arm 260 is locked by being caught by the restraint maintaining part 230, only when the operation lever 265 should be manipulated, the locked state can be changed to the released state.

The fabricator can operate the operation lever 265 to make the movement supporter 250 into a movable state. When the fabricator lifts the operation lever 265, the entire movement supporter 250 may be turned at a predetermined angle. In the above process, a locked state in which the restraint head 260a of the supporter restraint arm 260 is caught by the restraint maintaining part 230 of the mounting base 210 may be released. For reference, based on the front space of the lower door 70, when the fabricator pushes the operation lever 265 toward the storage space, the entire movement supporter 250 may be turned by a predetermined angle. Herein, as described above, the guide head 255a and the edge of the guide slot 225 are spaced apart from each other, so the guide head 255a is prevented from interfering with a bottom surface of the mounting base 210 when the movement supporter 250 is turned.

For convenience of operation, in the embodiment, the movement supporter 250 may include a pair of operation levers 265 protruding from a lower end portion of the movement supporter 250. More specifically, a first end of the pair of operation levers 265 may be connected to the lower end of the movement supporter 250, and a second end thereof may protrude downward, i.e., toward the connector inlet 73a of the connector storage part CM. The operation lever 265 may have a kind of cantilever structure.

The operation lever 265 may include the gripping end 267. The gripping end 267 may have a shape bent from the second end of each operation lever 265. The gripping end 267 may have roughly a “U” shape. Accordingly, the fabricator can easily grip the gripping end 267 and lift the operation lever 265. The process in which the fabricator lifts the operation lever 265 to release the locked state will be described below again.

Referring to FIG. 22, the movement supporter 250 and the connector assembly C may be assembled to the mounting base 210. Herein, the movement supporter 250 and the connector assembly C may be disposed at the storage position. Therefore, not only the movement supporter 250 but also the connector assembly C may not be exposed downward of the connector storage part CM (leftward direction based on the drawing). Herein, the second position fixation part 257 of the movement supporter 250 may be caught by the storage locking end 227a in the first position fixation part 227 of the mounting base 210. Therefore, the movement supporter 250 and the connector assembly C may not be moved in a direction toward the operation position (leftward direction based on the drawing) and remain fixed. Reference numeral 221a indicates a movement space having a shape in which a part of the mounting base 210 is recessed so that the guide head 255a is moved.

Herein, as illustrated in the drawing, the guide head 255a provided in the guide arm 255 of the movement supporter 250 may pass through the guide slot 225 of the mounting base 210. Therefore, the movement supporter 250 and the connector assembly C may be prevented from being separated in a direction (upward direction based on the drawing) perpendicular to the movement direction of the movement supporter 250. Since the movement arm is inserted into the guide slot 225, the movement of the movement supporter 250 may also be guided.

Referring to FIG. 23 without the movement supporter 250 and the connector assembly C, the movement supporter 250 may be moved in the arrow direction. To this end, first, the fabricator can access the connector inlet 73a to lift the gripping end 267 of the operation lever 265. The lifting direction may be a direction (upward direction based on the drawing) perpendicular to the movement direction of the movement supporter 250.

FIG. 24 illustrates the movement supporter 250 fixed to the mounting base 210. As illustrated in the drawing, the guide head 255a of the guide arm 255 is inserted into the guide slot 225. Accordingly, vertical movement (based on the drawing) of the movement supporter 250 is limited. At the same time, the second position fixation part 257 may be caught by the first position fixation part 227. Since either side surface of the movement supporter 250 are surrounded by the guide fence 212, transverse movement (based on the drawing) may also be limited. Eventually, the movement supporter 250 and the connector assembly C may be fixed in all directions at the storage position.

For reference, in FIG. 24, reference numeral 268 indicates a supporter foot provided at the movement supporter 250. The supporter foot 268 may protrude on a lower surface of the movement supporter 250 facing the surface of the mounting base 210. The supporter foot 268 may reduce a contact area between the movement supporter 250 and the mounting station 220, thereby reducing a friction force when the movement supporter 250 is moved.

FIGS. 25 and 26 illustrate the movement supporter 250 and the connector assembly C in the storage position at different angles. As illustrated in the drawings, the movement supporter 250 and the connector assembly C may be spaced apart upward from the lower end of the mounting base 210. The mounting stopper 229 may be caught by the stopping holder 259, so the movement supporter 250 may no longer be moved upward. The second position fixation part 257 may be caught by the storage locking end 227a provided at the first end of the first position fixation part 227. Furthermore, the guide head 255a of the guide arm 255 is in a state of being inserted into the guide slot 225.

In this state, when the movement supporter 250 is moved in the arrow direction, the connector assembly C may also be moved with the movement supporter 250. When the movement supporter 250 starts to be moved from the storage position, the second position fixation part 257 should pass over the storage locking end 227a. When the fabricator pulls the movement supporter 250, the second position fixation part 257 is elastically deformed in a direction toward the surface of the movement supporter 250 and may pass over the storage locking end 227a. Herein, the fabricator can access the movement supporter 250 through the connector inlet 73a (referring to FIG. 10) and pull the operation lever 265.

FIGS. 27 and 28 illustrate the movement supporter 250 and the connector assembly C moved and disposed in the operation position. The movement of the movement supporter 250 and the connector assembly C may be guided by the guide arm 255 inserted in the guide slot 225. In the movement process, the second position fixation part 257 may continuously pass the first position fixation part 227. Herein, the second position fixation part 257 is engaged with the continuous uneven part of the first position fixation part 227, thereby repeating elastic deformation and recovery of an original form.

When the movement supporter 250 and the connector assembly C are moved to the operation position, the entire relative connector 290 and a part of the door connector 270 may be exposed outward of the mounting base 210. The protruding portion may be disposed at the connector inlet 73a so the fabricator can check with the naked eye.

When the movement supporter 250 is moved to the operation position, the movement supporter 250 may be fixed at the operation position. Herein, fixing means a state of the movement supporter 250 not arbitrarily moved by an external force and may be a locked state of the movement supporter 250. When the movement supporter 250 is in the locked state, the connector assembly C may also be in the locked state. Therefore, an operation of assembling or separating the connector assembly C can be easily performed.

Specifically, in the embodiment, the door connector 270 may be mounted to the movement supporter 250 and moved together, so that the door connector 270 can be moved while facing in a constant direction. More specifically, the assembly surface 271a of the door connector 270 may be moved while facing the connector inlet 73a. Accordingly, when the door connector 270 is moved to the operation position, the assembly surface 271a may be exposed outward of the connector inlet 73a, and the assembling/separating operation of the connector can be easily performed.

When the movement supporter 250 is moved to the operation position, the restraint head 260a of the supporter restraint arm 260 may maintain the locked state in which the restraint head 260a is caught by the restraint maintaining part 230 of the mounting base 210. FIG. 29 illustrates the movement supporter 250 and the connector assembly C, the movement supporter 250 and the connector assembly C being moved to the operation position and the assembly surface 271a of the door connector 270 and the operation lever 265 being exposed outward of the mounting base 210. For reference, the relative connector 290 is omitted in FIG. 29.

Herein, the restraint head 260a of the supporter restraint arm 260 is caught by the restraint maintaining part 230 provided on either end of the mounting base 210. Accordingly, the movement supporter 250 may not be returned to the storage position and remain fixed at the operation position. In this state, when the relative connector 290 is assembled to the door connector 270, the door connector 270 maintains the fixed state, and connector assembly can be easily performed.

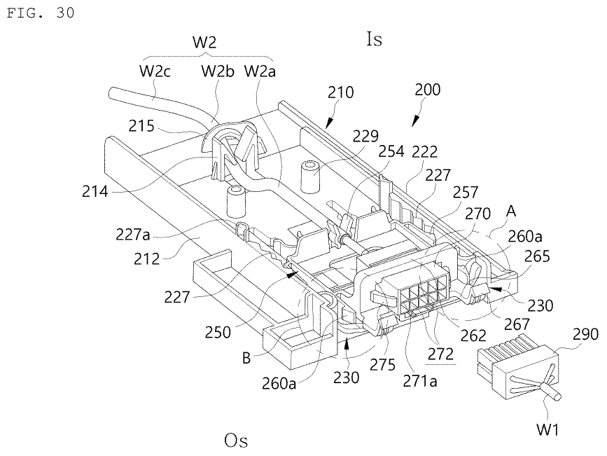

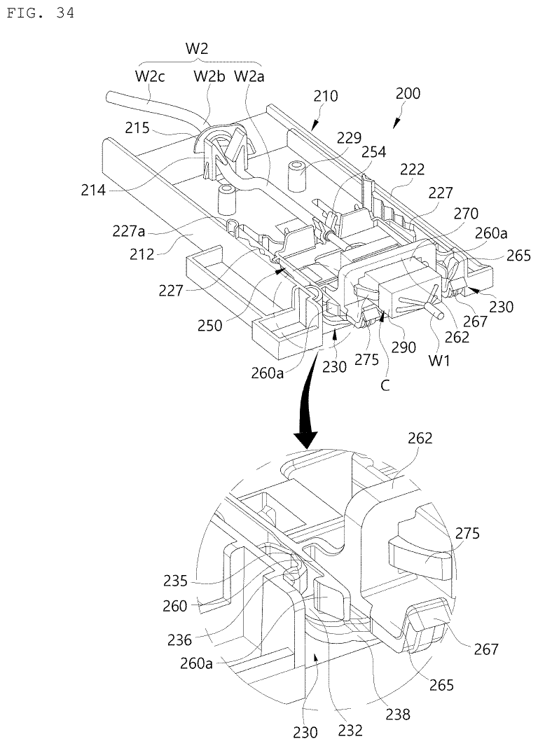

Referring to FIGS. 30 and 33, the structure in which the restraint head 260a is fixed to the restraint maintaining part 230 will be described. Referring to FIG. 30, the movement supporter 250 and the door connector 270 are disposed at the operation position, and the relative connector 290 may face the door connector 270 to be assembled. In this state, when the relative connector 290 is pushed toward the door connector 270, the two connectors may be assembled. Then, after the locked state is released by lifting the operation lever 265, the movement supporter 250 and the connector assembly C may be moved.

In part A of FIG. 30, the restraint maintaining part 230 is coupled to the restraint head 260a. FIG. 31 illustrates the restraint maintaining part 230 enlarged from part A of FIG. 30. As illustrated in the drawing, the restraint maintaining part 230 may be provided on the lower end of the mounting base 210. The restraint maintaining part 230 may include a locking step 231 and a releasing step 235. When the restraint head 260a of the supporter restraint arm 260 is caught by the locking step 231, the movement supporter 250 may be in the locked state. When the restraint head 260a is caught by the releasing step 235, the movement supporter 250 may be in the released state.

More specifically, the locking step 231 may be disposed below the releasing step 235. The locking step 231 may include a locking surface 232. The locking surface 232 may include a flat surface structure toward the connector inlet 73a. The restraint head 260a is fixed by being substantially caught by the locking surface 232.

The releasing step 235 may be provided above the locking step 231. When the supporter restraint arm 260 is raised, the restraint head 260a faces the releasing step 235. The releasing step 235 may be formed with a width gradually widened in the second direction toward the operation position.

The releasing step 235 may include a releasing surface 236 having an inclined surface or a curved surface. The releasing surface 236 may be formed in a direction of widening the width of the lower end of the mounting base 210. Accordingly, the restraint head 260a may be guided by the releasing surface 236. In this process, the supporter restraint arm 260 may be elastically deformed in a shape closed in a direction toward a side surface of the movement supporter 250.

The restraint maintaining part 230 may include an assembly guide 238. The assembly guide 238 may protrude from a lower end surface of the restraint maintaining part 230. The assembly guide 238 may be formed in a rib shape on the lower end surface of the restraint maintaining part 230. In the embodiment, an end portion 239 of the assembly guide 238 may have a shape partially surrounding the locking surface 232 and the releasing surface 236 and may be formed into a curved path. The assembly guide 238 may have a shape corresponding to the shape of the connector inlet 73a.

The assembly guide 238 may have a spacing between the assembly guide 238 and the operation lever 265. When the fabricator pushes a finger into the spacing, the fabricator can easily lift the operation lever 265. The fabricator can clear a position where the operation lever 265 should be operated, through the assembly guide 238.

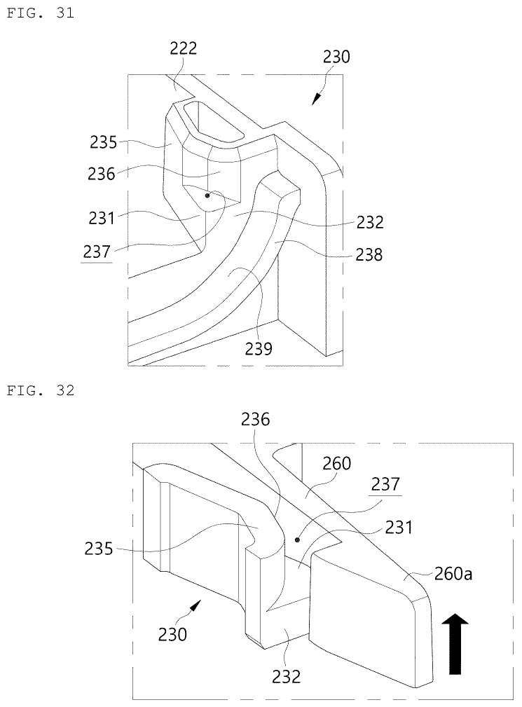

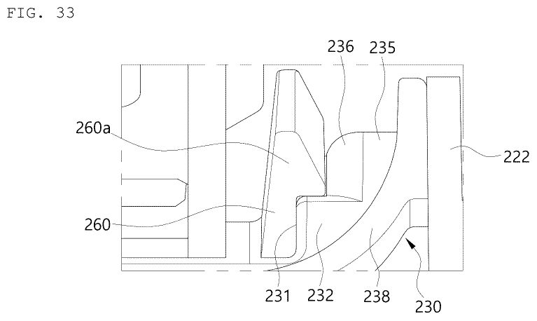

FIG. 32 illustrates the restraint head 260a caught by the locking surface 232 of the locking step 231. In this state, the restraint head 260a and the locking surface 232 are brought into surface contact with each other, so that the movement of the restraint head 260a may be limited as the restraint head 260a is caught by the locking surface 232. To release the locked state, the restraint head 260a should be separated from the locking surface 232.

As illustrated in FIG. 32, the releasing step 235 may have a transverse width smaller than the locking step 231. Accordingly, a releasing space 237, i.e., a kind of empty space, may be provided between the locking step 231 and the releasing step 235. When the restraint head 260a is located in the releasing space 237, releasing of the movement supporter 250 may start.

FIG. 33 illustrates the restraint head 260a facing the releasing surface 236. In FIG. 32, when the supporter restraint arm 260 is raised in the arrow direction, the restraint head 260a may face the releasing surface 236. Herein, the restraint head 260a and the releasing surface 236 are not in surface contact with each other, and the curved surface or the inclined surface of the releasing surface 236 and the restraint head 260a may be brought into linear contact with each other. Therefore, the restraint head 260a may be guided along the releasing surface 236, and the supporter restraint arm 260 may be elastically deformed in a direction closed inward.

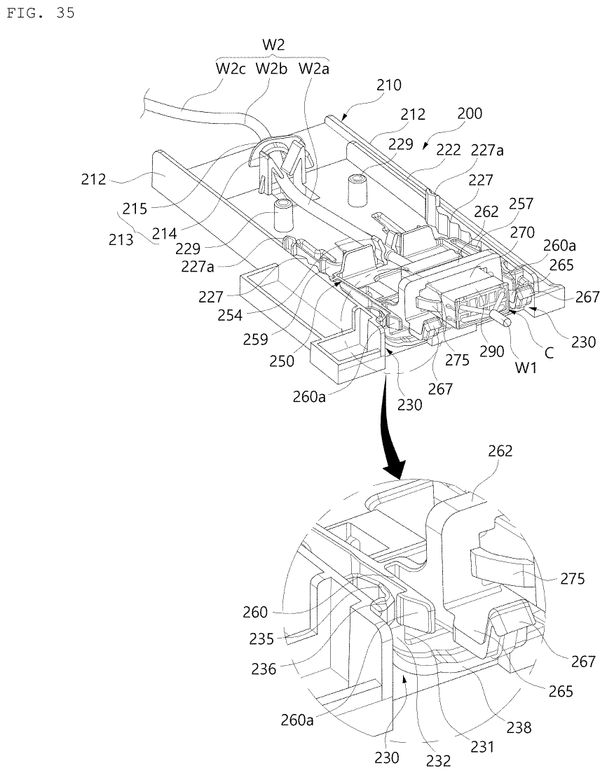

FIGS. 34 and 35 illustrate the connector assembly C mounted to the movement supporter 250. Herein, in FIG. 34, the movement supporter 250 is locked at the operation position, and in FIG. 35 the movement supporter 250 is released at the operation position. In the enlarged view of FIG. 34, the restraint head 260a of the supporter restraint arm 260 is caught by the locking surface 232 of the locking step 231. In this state, the restraint head 260a and the locking surface 232 are brought into surface contact with each other, so that the movement of the restraint head 260a may be limited as the restraint head 260a is caught by the locking surface 232. Herein, the operation lever 265 may be spaced apart from the assembly guide 238.

In this state, when the fabricator lifts the gripping end 267 of the operation lever 265, the restraint head 260a may be released from the state caught by the locking surface 232. The released state is illustrated in the enlarged view of FIG. 35. In FIG. 35, the fabricator lifts the operation lever 265, and the movement supporter 250 and the connector assembly C are entirely turned. When the movement supporter 250 is turned, the restraint head 260a is separated from the locking surface 232 and faces the releasing surface 236.

Herein, the turning direction of the movement supporter 250 may be a third direction that is different from both the first direction in which the movement supporter 250 is mounted to the mounting base 210 and the second direction in which the movement supporter 250 is moved along the mounting base 210.

FIG. 36 illustrates an angle of a in which the movement supporter 250 is turned. The guide head 255a secures an extra length by a predetermined distance with respect to the guide slot 225, so the movement supporter 250 may be turned. As described above, while the movement supporter 250 is turned by the angle of a, the movement supporter 250 may be moved to the storage position. Of course, in the movement process, the second position fixation part 257 may be moved by being continuously engaged with the first position fixation part 227. In the process, the second position fixation part 257 may perform continuously elastic deformation and recovery of an original form.

The connector inlet 73a may include a mounting cover 280. Referring to FIG. 3, the mounting cover 280 may block the connector inlet 73a, thereby covering the connector assembly C. More specifically, the mounting cover 280 may allow the pass of the main wire W1 extending from the relative connector 290, and cover the lower portion of the relative connector 290.

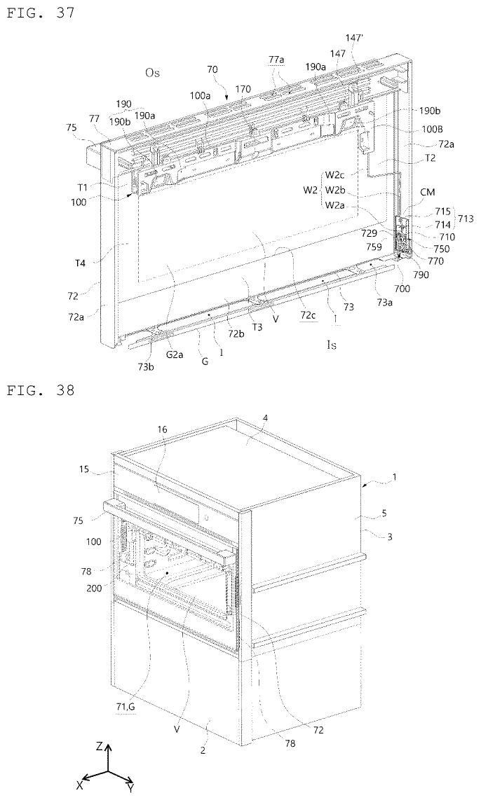

FIG. 37 illustrates the second embodiment of a connector module 700 constituting the door for a home appliance according to the present disclosure. The structure overlapped with the above-described embodiment is assigned with the same reference numeral in the 700's, and a detailed description will be omitted.

The connector storage part CM may be provided in the lower door 70. The connector storage part CM may be provided in the door body in the lower door 70. The connector storage part CM may be provided in the front frame part 72 constituting a frame of the door body. The front side plates 72a, i.e., a part of the front frame part 72, may constitute both side surfaces of the door body. As described above, the connector storage part CM may be provided in a front side plate 72a constituting both side surfaces of the door body.

As illustrated in FIG. 37, the connector module 700 may stand in the connector storage part CM. The connector module 700 is not seated on the front panel Ga, and may be disposed in the connector storage part CM provided in the front side plate 72a. A transverse width of the connector module 700 may be formed equal to or smaller than the width of each front side plate 72a. Since the connector storage part CM is provided at the lower end of the front frame part 72, the fabricator can easily access the connector module 700 through the connector inlet 73a of the lower door 70.

Herein, each front side plate 72a has roughly a concavely “C” shape, and the connector storage part CM may be provided in the concave portion. The connector storage part CM may be integrally formed with the front side plate 72a. Accordingly, the door connector 770 may be linearly moved along the concave portion of the front side plate 72a.

Although not shown in the drawing, the movement supporter 750 may be moved transversely with respect to the mounting base 710. Based on FIG. 37, the movement supporter 750 may be moved in the transverse direction, i.e., the width direction of the lower door 70, not the vertical direction.

FIG. 38 illustrates another example of a home appliance according to the present disclosure. As illustrated in the drawing, the home appliance may be a built-in type of home appliance. For example, the home appliance may be a cooking appliance installed in a built-in manner. The cooking appliance of the embodiment may be installed in kitchen furniture 1, etc., and the front surface of the cooking appliance may only be exposed forward. A lower part, a rear surface 3, an upper surface 4, and a side surface 5 of the kitchen furniture 1 may shield portions of the home appliance excluding the operating part 15, the display 16, the door 70, etc. that are disposed at the front surface of the home appliance. The image acquisition module 100 and the connector module 300 which are described above may be disposed in the lower door 70.

In the embodiment, the window may be omitted in the door 70. The inside space of the cooking appliance is not visible through the door 70, and may be checked only by the image acquisition module 100. Since there is no need to worry about the image acquisition module 100 being exposed forward of the cooking appliance through the window, the image acquisition module 100 may be disposed in a central region in the door 70.

Although the preferred embodiments of the present disclosure have been described for illustrative purposes, those skilled in the art will appreciate that various modifications, additions and substitutions are possible, without departing from the scope and spirit of the present disclosure as disclosed in the accompanying claims. Therefore, the preferred embodiments described above have been described for illustrative purposes, and should not be intended to limit the technical spirit of the present disclosure, and the scope and spirit of the present disclosure are not limited to the embodiments. The protective scope of the present disclosure should be interpreted by the accompanying claims, and all technical spirits within the equivalent scope should be interpreted as being included in the scope and spirit of the present disclosure.

What is claimed is:

1. A door for an appliance, the door comprising:
a door body configured to be disposed at a front of a storage space of the appliance, the door body accommodating an electronic component therein; and
a connector module disposed in the door body and electrically connected to the electronic component through a door wire,
wherein the connector module comprises:
a mounting base fixed to an inside of the door body,
a movement supporter configured to move along the mounting base, and
a door connector disposed at the movement supporter and configured to move with the movement supporter along the mounting base,
wherein the movement supporter is mounted to the mounting base in a first direction, and
wherein the movement supporter is configured to move relative to the mounting base in a second direction that is different from the first direction.

2. The door of claim 1, wherein the movement supporter is mounted to a first position of the mounting base, and
wherein the movement supporter is configured to slide relative to the mounting base in the second direction from the first position to a second position of the mounting base.

3. The door of claim 1, wherein the mounting base defines a guide slot that extends in the second direction,
wherein the movement supporter comprises a guide arm that is inserted into the guide slot in the first direction, and
wherein the movement supporter is configured to, based on the guide arm being inserted into the guide slot, be restricted from being separated from the mounting base in a direction opposite to the first direction.

4. The door of claim 3, wherein the guide slot is configured to, in a state in which the guide arm is inserted into the guide slot, guide a movement of the movement supporter in the second direction.

5. The door of claim 3, wherein the guide slot has a slot entrance defining an opening width that is greater than opening widths of other portions of the guide slot,
wherein the guide arm comprises a guide head that is inserted into the slot entrance, and
wherein a thickness of the guide head is (i) greater than the opening widths of the other portions of the guide slot and (ii) less than or equal to the opening width of the slot entrance.

6. The door of claim 1, wherein the connector module further comprises a storage fixation part configured to fix the movement supporter to a storage position, and
wherein the storage fixation part comprises:
a first position fixation part disposed at the mounting base; and
a second position fixation part that is disposed at the movement supporter and configured to be caught by the first position fixation part to thereby fix the movement supporter to the storage position.

7. The door of claim 6, wherein the second position fixation part has a cantilever structure protruding from the movement supporter, and
wherein the second position fixation part comprises a fixation end portion that protrudes from an end of the second position fixation part and is supported by the first position fixation part.

8. The door of claim 6, wherein the first position fixation part extends in the second direction and defines a plurality of storage positions arranged in the second direction, and
wherein the second position fixation part is configured to be fixed at any of the plurality of storage positions of the first position fixation part.

9. The door of claim 6, wherein the first position fixation part is one of a pair of first position fixation parts that are disposed at side portions of the mounting base, and
wherein the second position fixation part is one of a pair of second position fixation parts that are disposed at side portions of the movement supporter and face the pair of first position fixation parts, respectively.

10. The door of claim 2, wherein the mounting base is configured to, while the movement supporter moving in the second direction, restrict the movement supporter from moving from the first position and the second position.

11. The door of claim 2, wherein the connector module further comprises a mounting stopper that protrudes from the mounting base and is configured to interfere with the movement supporter at the first position.

12. The door of claim 1, wherein the mounting base comprises a restraint maintaining part configured to move in the second direction and to interfere with a part of the movement supporter to thereby restrict the movement supporter from moving from an operation position.

13. The door of claim 12, wherein the movement supporter is configured to be released from the mounting base based on turning in a third direction that is different from the first direction and the second direction.

14. The door of claim 12, wherein the movement supporter comprises a supporter restraint arm that is elastically deformable and configured to interfere with the restraint maintaining part.

15. The door of claim 14, wherein the supporter restraint arm is configured to, based on being turned or elastically deformed, be released from interference with the restraint maintaining part.

16. The door of claim 14, wherein the restraint maintaining part comprises:
a locking step configured to fix the supporter restraint arm based on interfering with the supporter restraint arm, the locking step having a first height; and
a releasing step configured to release interference with the supporter restraint arm, the releasing step having a second height different from the first height of the locking step.

17. The door of claim 16, wherein the releasing step extends in a direction widening a movement path of the door connector along the second direction, and
wherein the releasing step has a releasing surface that is curved or inclined.

18. The door of claim 16, wherein the supporter restraint arm is configured to, based on the movement supporter being turned, move from a first position facing the locking step to a second position facing the releasing step.

19. The door of claim 1, wherein the door body comprises a door panel disposed at a central portion of the door body, the door panel comprising a window through which the storage space is visible,
wherein the door body defines an indoor space including an installation region disposed around an outer portion of the window of the door panel, and
wherein the connector module is disposed in the installation region.

20. An appliance comprising:
a main body that defines a storage space;
a door body that is disposed at a front of the storage space and accommodates an electronic component therein; and
a connector module disposed in the door body and electrically connected to the electronic component through a door wire,
wherein the connector module comprises:
a mounting base fixed to an inside of the door body,
a movement supporter configured to move along the mounting base, and
a door connector disposed at the movement supporter and configured to move with the movement supporter along the mounting base,
wherein the movement supporter is mounted to the mounting base in a first direction, and
wherein the movement supporter is configured to move relative to the mounting base in a second direction that is different from the first direction.
